(19) United States
(12) Patent Application Publication
(10) Pub. No.: US 2026/0240186 A1
(43) Pub. Date: Aug. 20, 2026

(54) OIL OR FAT COMPOSITION FOR FOOD PREPARATION, FOOD, POWDERED OIL OR FAT, METHOD FOR PRODUCING OIL OR FAT COMPOSITION FOR FOOD PREPARATION, METHOD FOR PREPARING FOOD, METHOD FOR COOKING FOOD, METHOD FOR IMPROVING QUALITY OF FOOD, AND METHOD FOR IMPROVING QUALITY OF COOKED FOOD

(71) Applicant: J-OIL MILLS, INC., Tokyo (JP)

(72) Inventors: Ryosuke AOKI, Tokyo (JP); Masashi IWASAKI, Tokyo (JP); Hotaka YATSU, Tokyo (JP); Masayoshi SAKAINO, Tokyo (JP); Mina YOSHIMURA, Tokyo (JP); Tsubasa IKEYA, Tokyo (JP)

(21) Appl. No.: 19/165,427

(22) PCT Filed: Mar. 19, 2024
(86) PCT No.: PCT/JP2024/010685

§ 371 Date: Sep. 15, 2025

(30) Foreign Application Priority Data
Mar. 30, 2023 (JP) 2023-055842

(51) Int. Cl. A23D 9/05; A23L 5/10; C11C 3/00

(52) U.S. Cl. CPC A23D 9/05; A23L 5/11; C11C 3/003

(57) ABSTRACT

An oil or fat composition for food preparation containing: a glycerin fatty acid ester containing a fatty acid residue having 13 or more and 15 or less carbon atoms, in which oil or fat composition for food preparation contains 1.8% by mass or more and 100% by mass or less of a fatty acid having 13 or more and 15 or less carbon atoms in total fatty acids of the glycerin fatty acid ester, and in the total fatty acids of the glycerin fatty acid ester, a content of a fatty acid having 12 carbon atoms is 0 or more and 2.5 or less in terms of a mass ratio with respect to a content of the fatty acid having 13 or more and 15 or less carbon atoms (excluding an oil or fat composition for preparation of puff pastry margarine, and the oil or fat composition for food preparation that is milk fat, beef tallow, mutton tallow, ucuuba butter, murumuru butter, euglena oil, or margarine).

### TECHNICAL FIELD

The present invention relates to an oil or fat composition for food preparation, food, a powdered oil or fat, a method for producing an oil or fat composition for food preparation, a method for preparing food, a method for cooking food, a method for improving quality of food, and a method for improving quality of cooked food.

### BACKGROUND ART

Examples of the oil or fat suitable for the preparation or cooking of food include those described in Patent Documents 1 to 3.

Patent Document 1 discloses a stir-frying cooking method in which a heating surface temperature during the stir-frying cooking is 220° C. or higher, and the stir-frying is performed with a stir-frying oil containing 0.2% to 12% by mass of an emulsifier A and/or an emulsifier B. The emulsifier A is a polyglycerin fatty acid ester in which the average degree of polymerization of polyglycerin constituting the polyglycerin fatty acid ester is 4 or more and the average esterification rate is 25% to 50%, and the emulsifier B is a polyglycerin condensed ricinoleic acid ester. According to the stir-frying cooking method, stir-frying cooking at the heating surface temperature of 220° C. or higher can be realized, and since the heating temperature is high, the time for stir-frying cooking is also shortened. In stir-frying cooking at a high temperature, it is possible to suppress burning. Since it is possible to realize an environment for high-temperature stir-frying cooking in which fuming is also less in stir-frying cooking at a high temperature, it is possible to improve the work environment for high-temperature stir-frying cooking.

Patent Document 2 discloses an edible oil or fat in which (1) the content of a medium-chain saturated acyl group having 8 to 10 carbon atoms is 5% to 20% by weight among all the constituent acyl groups in the oil or fat, (2) the content of the triglyceride in which the sum of the number of carbon atoms in the constituent acyl groups is 30 or less is less than 1% by weight of the triglyceride components, and 32 to 38 is less than 15% by weight among the triglyceride components, and (3) the content of the monoglyceride is less than 3% by weight, the content of the diglyceride is 2.5% by weight or more and less than 15% by weight, and the content of the triglyceride is 85% by weight or more and less than 97.5% by weight among all the glyceride components, and it is described that the edible oil or fat can stably dissolve and contain plant sterols and have excellent heat cooking suitability such as less fuming during heat cooking and less foaming during frying cooking.

Patent Document 3 discloses a method for producing a powdered oil or fat composition containing an oil or fat component containing one or more XXX-type triglycerides having a fatty acid residue X having x carbon atoms at the positions 1 to 3 of glycerin, in which the number of carbon atoms x is an integer selected from 16 to 20, the oil or fat component contains a B-type oil or fat, the loose bulk density of the powdered oil or fat composition is 0.05 to 0.6 g/cm³, and the method includes the following steps: (a) a step of preparing a solid oil or fat composition raw material containing the XXX-type triglyceride; (b) a step of heating the solid oil or fat composition raw material obtained in the step (a) at a temperature lower than a melting point to change the oil or fat component in the solid oil or fat composition raw material into a B-type oil and obtain a B-type oil or fat-containing composition raw material; and (c) a step of pulverizing the β-type oil or fat-containing composition raw material obtained in the step (b) by a collision between the raw materials without mechanical pulverization to obtain a powdered oil or fat composition. According to the method for producing a powdered oil or fat composition, it is possible to provide a method for producing a powdered oil or fat composition containing an oil or fat component containing XXX-type triglyceride, and it is possible to provide a method for producing a powdered oil or fat composition containing a B-type oil or fat as the oil or fat component and having a specific loose bulk density and the like.

### RELATED DOCUMENT

### Patent Document

Patent Document 1: Japanese Unexamined Patent Publication No. 2021-048828
Patent Document 2: Japanese Unexamined Patent Publication No. 2001-211828
Patent Document 3: Japanese Unexamined Patent Publication No. 2022-171316

### SUMMARY OF THE INVENTION

### Technical Problem

The present invention provides an oil or fat composition for food preparation which is preferable for preparing food.

### Solution to Problem

The present inventors have found that in a glycerin fatty acid ester containing a fatty acid residue having 13 or more and 15 or less carbon atoms, an oil or fat composition for food preparation, which is preferable for preparing food, can be obtained by, in total fatty acids of the glycerin fatty acid ester, setting a content of a fatty acid having 13 or more and 15 or less carbon atoms to be within a predetermined range and setting a mass ratio of a content of a fatty acid having 12 carbon atoms with respect to the content of the fatty acid having 13 or more and 15 or less carbon atoms to be within a predetermined range.

The present invention provides the following oil or fat composition for food preparation, food, powdered oil or fat, method for producing oil or fat composition for food preparation, method for preparing food, method for cooking food, method for improving quality of food, and method for improving quality of cooked food.
[1]

An oil or fat composition for food preparation containing:
a glycerin fatty acid ester containing a fatty acid residue having 13 or more and 15 or less carbon atoms,
wherein in total fatty acids of the glycerin fatty acid ester, a content of a fatty acid having 13 or more and 15 or less carbon atoms is 1.8% by mass or more and 100% by mass or less and
in the total fatty acids of the glycerin fatty acid ester, a content of a fatty acid having 12 carbon atoms is 0 or more and 2.5 or less in terms of a mass ratio with respect to a content of the fatty acid having 13 or more and 15 or less carbon atoms (excluding an oil or fat composition for preparation of puff pastry margarine, and the oil or fat composition for food preparation that is milk fat, beef tallow, mutton tallow, ucuuba butter, murumuru butter, euglena oil, or margarine).
[2]

The oil or fat composition for food preparation according to [1],
in which the fatty acid having 13 or more and 15 or less carbon atoms includes one kind or two or more kinds selected from the group consisting of tridecanoic acid, tetradecanoic acid, and pentadecanoic acid.
[3]

The oil or fat composition for food preparation according to [1] or [2],
in which in the total fatty acids of the glycerin fatty acid ester, a content of a fatty acid having 12 carbon atoms is 0% by mass or more and 15% by mass or less.
[4]

The oil or fat composition for food preparation according to any one of [1] to [3],
in which in the total fatty acids of the glycerin fatty acid ester, a content of a fatty acid having 14 carbon atoms is 1.5% by mass or more and 100% by mass or less.
[5]

The oil or fat composition for food preparation according to any one of [1] to [4],
in which the glycerin fatty acid ester contains a transesterified oil.
[6]

The oil or fat composition for food preparation according to any one of [1] to [5],
in which the oil or fat composition for food preparation is used for cooking.
[7]

The oil or fat composition for food preparation according to [6],
in which the oil or fat composition for food preparation is used for one kind selected from the group consisting of frying oil, coating oil, anti-sticking oil for noodles, stir-frying oil, and oil for raw use.
[8]

The oil or fat composition for food preparation according to [6],
in which the oil or fat composition for food preparation is used for anti-sticking oil for rice cooking.
[9]

The oil or fat composition for food preparation according to any one of [6] to [8],
in which a solid fat content (SFC) of the oil or fat composition for food preparation at 10° C. is 0% or more and 90% or less.

The oil or fat composition for food preparation according to any one of [6] to [9],
in which a solid fat content (SFC) of the oil or fat composition for food preparation at 20° C. is 0% or more and 80% or less.
[11]

The oil or fat composition for food preparation according to any one of [1] to [5],
in which the oil or fat composition for food preparation is used for preparing a powdered oil or fat.
[12]

Food containing:
the oil or fat composition for food preparation according to any one of [1] to [11].
[13]

A powdered oil or fat containing:
the oil or fat composition for food preparation according to any one of [1] to [5] and [11].
[14]

A method for producing an oil or fat composition for food preparation according to any one of [1] to [11], the method including:
a step of reacting a fatty acid having 13 or more and 15 or less carbon atoms with glycerin to produce a glycerin fatty acid ester.
[15]

The method for producing an oil or fat composition for food preparation according to [14], further including:
a step of subjecting the glycerin fatty acid ester obtained by reacting the fatty acid having 13 or more and 15 or less carbon atoms with the glycerin to a transesterification with an edible oil or fat containing a glycerin fatty acid ester other than the glycerin fatty acid ester.
[16]

A method for preparing food, including:
a step of preparing food using the oil or fat composition for food preparation according to any one of [1] to [11].

A method for cooking food, including:
a step of cooking food using the oil or fat composition for food preparation according to any one of [1] to [10].
[17]

A method for improving quality of food, including:
a step of preparing food using the oil or fat composition

for food preparation according to any one of [1] to [11].
[19]

A method for improving quality of cooked food, including:
a step of cooking food using the oil or fat composition for food preparation according to any one of [1] to [10].

### Advantageous Effects of Invention

According to the present invention, it is possible to provide an oil or fat composition for food preparation which is preferable for preparing food.

### DESCRIPTION OF EMBODIMENTS

Hereinafter, embodiments of the present invention will be described with specific examples of each component. In the present specification, unless otherwise specified, “A to B” indicating a numerical range means equal to or more than A and equal to or less than B. In addition, in the present specification, when an upper limit value and a lower limit value of a numerical range are indicated, the upper limit value and the lower limit value can be appropriately combined, and the numerical range obtained by the combination is also disclosed.

### (Oil or Fat Composition for Food Preparation)

The oil or fat composition for food preparation according to the present embodiment contains a glycerin fatty acid ester containing a fatty acid residue having 13 or more and 15 or less carbon atoms, in which the oil or fat composition for food preparation contains 1.8% by mass or more and 100% by mass or less of a fatty acid having 13 or more and 15 or less carbon atoms in total fatty acids of the glycerin fatty acid ester, and a content of a fatty acid having 12 carbon atoms is 0 or more and 2.5 or less in terms of a mass ratio with respect to the content of the fatty acid having 13 or more and 15 or less carbon atoms in the total fatty acids of the glycerin fatty acid ester. However, the oil or fat composition for food preparation excludes an oil or fat composition for preparation of puff pastry margarine, and an oil or fat composition for food preparation that is milk fat, beef tallow, mutton tallow, ucuuba butter, murumuru butter, euglena oil, or margarine.

The euglena oil refers to an oily component extracted from at least one of cells of euglena (a kind of microalgae classified into Euglena genus) or a culture medium in which the euglena is cultured.

In the present embodiment, the glycerin fatty acid ester represents a compound in which glycerin and one or more and three or less fatty acids are ester-bonded. In the present embodiment, the glycerin fatty acid ester is preferably an ester in which three fatty acids are bonded to glycerin.

Examples of the aspect of the oil or fat composition for food preparation of the present embodiment include the following (i) to (iv).
(i) oil or fat composition for food preparation used for cooking
(ii) oil or fat composition for food preparation used for preparing a powdered oil or fat
(iii) oil or fat composition for food preparation used for supplement
(iv) oil or fat composition for food preparation used for food for elderly people

Hereinafter, the oil or fat composition for food preparation of each aspect will be described.

The configurations of the respective aspects can be appropriately combined.

### First Embodiment

In a first embodiment, the oil or fat composition for food preparation is preferably used for cooking. The cooking method will be described later.

In the glycerin fatty acid ester in the oil or fat composition for food preparation, the content of the fatty acid having 13 or more and 15 or less carbon atoms in the total fatty acids of the glycerin fatty acid ester is 1.8% by mass or more, preferably 1.9% by mass or more, more preferably 2.0% by mass or more, still more preferably 3.0% by mass or more, even still more preferably 4.0% by mass or more, and even further still more preferably 5.0% by mass or more, and is 100% by mass or less, and may be 99% by mass or less, may be 95% by mass or less, may be 90% by mass or less, may be 85% by mass or less, may be 80% by mass or less, or may be 75% by mass or less.

When the content of the fatty acid having 13 or more and 15 or less carbon atoms is within the above-described range, the suitability for heat cooking can be improved by suppressing fuming when the oil or fat composition for food preparation is used for heat cooking. In addition, the flavor and texture of the obtained food can be improved.

In the glycerin fatty acid ester in the oil or fat composition for food preparation, in the total fatty acids of the glycerin fatty acid ester, a mass ratio of a content of a fatty acid having 12 carbon atoms with respect to the content of the fatty acid having 13 or more and 15 or less carbon atoms is 2.5 or less, preferably 2.3 or less, more preferably 2.1 or less, still more preferably 1.8 or less, even still more preferably 1.5 or less, and even further still more preferably 1.0 or less, and is 0 or more.

When the mass ratio of the content of the fatty acid having 12 carbon atoms with respect to the content of the fatty acid having 13 or more and 15 or less carbon atoms is within the above-described range, the suitability for heat cooking can be improved by suppressing fuming when the oil or fat composition for food preparation is used for heat cooking. In addition, the flavor and texture of the obtained food can be improved.

The present inventors have found that, in the oil or fat composition for food preparation of the present embodiment, by setting the content of the fatty acid having 13 or more and 15 or less carbon atoms and the mass ratio of the content of the fatty acid having 12 carbon atoms with respect to the content of the fatty acid having 13 or more and 15 or less carbon atoms within a predetermined range, it is possible to suppress the fuming of the oil or fat composition for food preparation in a case of performing heat cooking. The reason for this is not clear, but it is considered that the content of the fatty acid having 12 carbon atoms, which is more susceptible to hydrolysis and has a lower boiling point than the fatty acid having 13 or more and 15 or less carbon atoms, is relatively decreased. It is considered that the suitability for heat cooking such as frying or stir-frying at a high temperature is improved by suppressing the fuming.

In addition, it has been found that, with the oil or fat composition for food preparation of the present embodiment, for example, in cooking other than heat cooking, such as preparation of a salad or mayonnaise, it is possible to obtain an effect of improving the flavor and stability of the obtained food.

In the glycerin fatty acid ester in the oil or fat composition for food preparation, from the viewpoint of further suppressing fuming when the oil or fat composition for food preparation is used for heat cooking, improving cooking suitability, and further improving the flavor and texture of the obtained food, the content of the fatty acid having 12 carbon atoms in the total fatty acids of the glycerin fatty acid ester is preferably 15% by mass or less, more preferably 14% by mass or less, still more preferably 13% by mass or less, even still more preferably 10% by mass or less, and even further still more preferably 5% by mass or less. The lower limit of the content of the fatty acid having 12 carbon atoms is not limited, but is, for example, 0% by mass or more.

In the glycerin fatty acid ester in the oil or fat composition for food preparation, from the viewpoint of further improving cooking suitability and the viewpoint of further improving the function of lowering the blood glucose level, a content of a fatty acid having 14 carbon atoms in the total fatty acids of the glycerin fatty acid ester is preferably 1.5% by mass or more, more preferably 1.8% by mass or more, still more preferably 2.0% by mass or more, even still more preferably 4.0% by mass or more, and even further still more preferably 4.5% by mass or more, and from the viewpoint of setting physical properties such as a melting point to a range more suitable for cooking, the content of the fatty acid having 14 carbon atoms in the total fatty acids of the glycerin fatty acid ester is preferably 100% by mass or less, more preferably 90% by mass or less, still more preferably 85% by mass or less, even still more preferably 80% by mass or less, and even further still more preferably 75% by mass or less.

The fatty acid having 13 or more and 15 or less carbon atoms preferably includes one kind or two or more kinds selected from the group consisting of tridecanoic acid, tetradecanoic acid, and pentadecanoic acid. Tridecanoic acid is a saturated fatty acid having 13 carbon atoms, tetradecanoic acid is a saturated fatty acid having 14 carbon atoms, and pentadecanoic acid is a saturated fatty acid having 15 carbon atoms. When the fatty acid having 13 or more and 15 or less carbon atoms is a saturated fatty acid, the physical properties of the oil or fat composition for food preparation can be set to a range more suitable for cooking.

In addition, tetradecanoic acid is abundantly contained in natural oils or fats such as palm kernel oil, palm oil, and milk fat.

The glycerin fatty acid ester in the oil or fat composition for food preparation of the present embodiment preferably includes a transesterified oil. When the transesterified oil is contained, the liquid state can be more easily maintained and the cooking suitability can be further improved when the oil or fat composition for food preparation is in a liquid state.

When the glycerin fatty acid ester contains the transesterified oil, the content of the transesterified oil with respect to the entire glycerin fatty acid ester is preferably 5% by mass or more, more preferably 10% by mass or more, and still more preferably 15% by mass or more, and is preferably 100% by mass or less.

When the glycerin fatty acid ester in the oil or fat composition for food preparation of the present embodiment contains the transesterified oil, the glycerin fatty acid ester may contain an edible oil or fat other than the transesterified oil. The edible oil or fat is not particularly limited, and examples thereof include vegetable oils or fats such as rapeseed oil, soybean oil, corn oil, sesame oil, palm oil, palm kernel oil, rice oil, cottonseed oil, safflower oil, sunflower oil, olive oil, linseed oil, peanut oil, sal fat, cacao butter, and shea butter; animal oils or fats such as beef tallow, pork fat, chicken fat, milk fat, and fish oil; and synthetic oils or fats such as medium-chain fatty acid triglycerides. In addition, examples thereof include processed oils or fats obtained by subjecting the above-described oils or fats to treatments such as separation and hydrogenation. Among these, one kind or two or more kinds selected from the group consisting of vegetable oils or fats and processed oils or fats thereof are preferable, and one kind or two or more kinds selected from the group consisting of rapeseed oil, soybean oil, palm oil, sunflower oil, and processed oils or fats thereof are more preferable. In addition, a transesterified oil other than the transesterified oil of the glycerin fatty acid ester containing a fatty acid residue having 13 or more and 15 or less carbon atoms described above may be contained. A raw material oil or fat of the transesterified oil can be appropriately selected from the edible oil or fat described above.

The oil or fat composition for food preparation of the present embodiment can be widely used for preparing food, but is preferably used for cooking, and more preferably used for one kind selected from the group consisting of frying oil, coating oil, anti-sticking oil for noodles, stir-frying oil, and oil for raw use.

In addition, the oil or fat composition for food preparation of the present embodiment is also preferably used for anti-sticking oil for rice cooking.

The frying oil is not limited as long as it is used for frying various foods, but for example, it is preferably used for frying fried chicken, fried bread, Tatsuta-age (Deep-fried marinated chicken), fried chicken, chicken nuggets, pork cutlet, minced meat cutlet, chicken cutlet, cream croquette, potato croquette, pumpkin croquette, fish fries, shrimp fries, oyster fries, squid fries, donut, tempura, french fries, and the like. By using the oil or fat composition for food preparation of the present embodiment for the purpose of frying these fried foods, the oiliness and the oily odor of the obtained fried foods can be suppressed, and the texture such as crispiness can be further improved.

As the coating oil, the balance between the hardness and the softness of noodles such as boiled spaghetti or Chinese noodles is improved by being entangled with the noodles, and the texture such as the appropriate firmness, elasticity, crispness, and stickiness can be further improved.

The anti-sticking oil for noodles can be applied to noodles such as boiled spaghetti or Chinese noodles to further improve looseness of the noodles.

The stir-frying oil is not limited as long as it is used for frying in a frying pan, a pot, or the like, but it is preferable that the frying oil is used for frying, for example, stir-fried vegetables, fried rice, yakisoba, steak, or the like. By using the oil or fat composition for food preparation of the present embodiment for the purpose of stir-frying these foods, it is possible to suppress the foods from being adhered to and burnt on a frying pan or a pot bottom.

Examples of the oil for raw use include a use application for preparing dressings and mayonnaises and directly pouring over salads, soups, tofu, and the like, and a use application for mixing the dressings and mayonnaises with salads, soups, tofu, and the like. By using the oil or fat composition for food preparation of the present embodiment for preparing dressing or mayonnaise, separation of oil and moisture can be further suppressed, and emulsification stability can be further improved.

The dispersibility of the oil or fat during rice cooking can be further improved by using the anti-sticking oil for rice cooking.

When the oil or fat composition for food preparation is used for cooking, from the viewpoint of improving handleability during cooking, the melting point of the oil or fat composition for food preparation is preferably 50° C. or lower, more preferably 45° C. or lower, and still more preferably 40° C. or lower. The lower limit of the melting point of the oil or fat composition for food preparation is not limited, but may be, for example, −10° C. or higher or 0° C. or higher.

When the oil or fat composition for food preparation is used for cooking, from the viewpoint of further improving the handleability, the iodine value of the oil or fat composition for food preparation is preferably 20 or more, more preferably 25 or more, and still more preferably 30 or more, and even still more preferably 35 or more, and from the viewpoint of further improving the storage stability, the iodine value is preferably 140 or less, more preferably 135 or less, and still more preferably 130 or less.

When the oil or fat composition for food preparation is used for cooking, the solid fat content (SFC) of the oil or fat composition for food preparation at 10° C. is preferably 0% or more, preferably 90% or less, and more preferably 87% or less. In addition, the solid fat content (SFC) of the oil or fat composition for food preparation at 10° C. is preferably 0% or more, preferably 90% or less, more preferably 87% or less, still more preferably 70% or less, even still more preferably 50% or less, even further still more preferably 30% or less, even further still more preferably 15% or less, and even further still more preferably 10% or less.

The solid fat content (SFC) of the oil or fat composition for food preparation at 20° C. is preferably 0% or more, more preferably 80% or less, and still more preferably 70% or less.

In addition, the solid fat content (SFC) of the oil or fat composition for food preparation at 20° C. is preferably 0% or more, preferably 80% or less, more preferably 70% or less, still more preferably 65% or less, even still more preferably 50% or less, even further still more preferably 25% or less, and even further still more preferably 10% or less.

The solid fat content (SFC) of the oil or fat composition for food preparation at 30° C. is preferably 0% or more, more preferably 60% or less, and still more preferably 50% or less.

In addition, the solid fat content (SFC) of the oil or fat composition for food preparation at 30° C. is preferably 0% or more, preferably 60% or less, more preferably 50% or less, still more preferably 40% or less, even still more preferably 30% or less, even further still more preferably 20% or less, and even further still more preferably 10% or less.

The solid fat content (SFC) of the oil or fat composition for food preparation at 35° C. is preferably 0% or more, preferably 50% or less, and more preferably 40% or less.

In addition, the solid fat content (SFC) of the oil or fat composition for food preparation at 35° C. is preferably 0% or more, preferably 50% or less, more preferably 40% or less, still more preferably 30% or less, even still more preferably 20% or less, even further still more preferably 10% or less, and even further still more preferably 5% or less.

When the solid fat content (SFC) of the oil or fat composition for food preparation is within the above-described range, the handleability can be further improved.

The solid fat content (SFC) of the oil or fat composition for food preparation can be measured according to Method I described in AOCS Official Method Cd 16-93.

### Second Embodiment

In a second embodiment, the oil or fat composition for food preparation is preferably used for preparing a powdered oil or fat.

In the glycerin fatty acid ester in the oil or fat composition for food preparation, the content of the fatty acid having 13 or more and 15 or less carbon atoms in the total fatty acids of the glycerin fatty acid ester is 1.8% by mass or more, preferably 3.08 by mass or more, more preferably 5.08 by mass or more, still more preferably 108 by mass or more, even still more preferably 15% by mass or more, and even further still more preferably 20% by mass or more, and is 100% by mass or less.

When the content of the fatty acid having 13 or more and 15 or less carbon atoms is within the above-described range, powder fluidity, emulsification stability, and flavor of the powdered oil or fat can be improved.

In the glycerin fatty acid ester in the oil or fat composition for food preparation, in the total fatty acids of the glycerin fatty acid ester, a mass ratio of a content of a fatty acid having 12 carbon atoms with respect to the content of the fatty acid having 13 or more and 15 or less carbon atoms is 2.5 or less, preferably 2.3 or less, more preferably 2.1 or less, still more preferably 1.8 or less, even still more preferably 1.5 or less, and even further still more preferably 1.0 or less, and is 0 or more.

When the mass ratio of the content of the fatty acid having 12 carbon atoms with respect to the content of the fatty acid having 13 or more and 15 or less carbon atoms is within the above-described range, powder fluidity, emulsification stability, and flavor of the powdered oil or fat can be improved.

The present inventors have found that, in the oil or fat composition for food preparation of the present embodiment, by setting the mass ratio of the content of the fatty acid having 12 carbon atoms with respect to the content of the fatty acid having 13 or more and 15 or less carbon atoms in the total fatty acids of the glycerin fatty acid ester within a predetermined range, it is possible to suppress the fuming of the oil or fat composition for food preparation in a case of performing heat cooking. The reason for this is not clear, but it is considered that the content of the fatty acid having 12 carbon atoms, which is more susceptible to hydrolysis and has a lower boiling point than the fatty acid having 13 or more and 15 or less carbon atoms, is relatively decreased. It was found that the physical properties suitable for the preparation of the powdered oil or fat, which is subjected to a heating preparation step such as spray drying, are obtained by suppressing the fuming during heating.

In the glycerin fatty acid ester in the oil or fat composition for food preparation, from the viewpoint of further suppressing fuming when the oil or fat composition for food preparation is used for heat cooking, and improving powder fluidity, emulsification stability, and flavor of the powdered oil or fat, the content of the fatty acid having 12 carbon atoms in the total fatty acids of the glycerin fatty acid ester is preferably 15% by mass or less, more preferably 14% by mass or less, still more preferably 13% by mass or less, even still more preferably 10% by mass or less, and even further still more preferably 5% by mass or less. The lower limit of the content of the fatty acid having 12 carbon atoms is not limited, but is, for example, 0% by mass or more.

In the glycerin fatty acid ester in the oil or fat composition for food preparation, from the viewpoint of improving powder fluidity, emulsification stability, and flavor of the powdered oil or fat, and from the viewpoint of further improving the function of lowering the blood glucose level, the content of the fatty acid having 14 carbon atoms in the total fatty acids of the glycerin fatty acid ester is preferably 1.5% by mass or more, more preferably 3.0% by mass or more, still more preferably 5.0% by mass or more, even still more preferably 10.0% by mass or more, and even further still more preferably 15.0% by mass or more, and is preferably 100% by mass or less.

The fatty acid having 13 or more and 15 or less carbon atoms preferably includes one kind or two or more kinds selected from the group consisting of tridecanoic acid, tetradecanoic acid, and pentadecanoic acid. Tridecanoic acid is a saturated fatty acid having 13 carbon atoms, tetradecanoic acid is a saturated fatty acid having 14 carbon atoms, and pentadecanoic acid is a saturated fatty acid having 15 carbon atoms. When where the fatty acid having 13 or more and 15 or less carbon atoms is a saturated fatty acid, powder fluidity, emulsification stability, and flavor of the powdered oil or fat can be improved.

In addition, tetradecanoic acid is abundantly contained in natural oils or fats such as palm kernel oil, palm oil, and milk fat.

The glycerin fatty acid ester in the oil or fat composition for food preparation of the present embodiment preferably includes a transesterified oil. When the transesterified oil is contained, the liquid state can be more easily maintained and the processing suitability of the powdered oil or fat can be further improved when the oil or fat composition for food preparation is in a liquid state.

When the glycerin fatty acid ester contains the transesterified oil, the content of the transesterified oil with respect to the entire glycerin fatty acid ester is preferably 5% by mass or more, more preferably 208 by mass or more, still more preferably 30% by mass or more, and even still more preferably 50% by mass or more, and is preferably 100% by mass or less and more preferably 95% by mass or less.

The powdered oil or fat is a powdered composition containing edible oil or fat, and is used for powdered milk for coffee, soup, side dishes, batter, seasoning, bread, confectionery, and the like. By using the oil or fat composition for food preparation of the present embodiment for preparing a powdered oil or fat, powder fluidity, emulsification stability, and flavor of the powdered oil or fat can be improved.

When the oil or fat composition for food preparation is used for preparing a powdered oil or fat, from the viewpoint of further improving the processing suitability to the powdered oil or fat, the melting point of the oil or fat composition for food preparation is preferably 70° C. or lower, more preferably 65° C. or lower, and still more preferably 60° C. or lower. The lower limit of the melting point of the oil or fat composition for food preparation is not limited, but may be, for example, 10° C. or higher or 20° C. or higher.

When the oil or fat composition for food preparation is used for preparing a powdered oil or fat, from the viewpoint of further improving the processing suitability to a powdered oil or fat, the iodine value of the oil or fat composition for food preparation is preferably 0 or more, and from the viewpoint of further improving the storage stability, the iodine value is preferably 110 or less, more preferably 100 or less, and still more preferably 90 or less.

From the viewpoint of cooking suitability and processing suitability to a powdered oil or fat, the glycerin fatty acid ester in the oil or fat composition for food preparation of the present embodiment is preferably a triglyceride containing a saturated fatty acid having 13 or more and 15 or less carbon atoms, and is a triglyceride in which all three fatty acids are the same and which is a vegetable oil and contains 128 by mass or more of an unsaturated fatty acid having 18 carbon atoms, and more preferably a triglyceride which is a vegetable oil and contains 12% by mass or more of an unsaturated fatty acid having 18 carbon atoms. In addition, the glycerin fatty acid ester in the oil or fat composition for food preparation is more preferably a vegetable oil and contains 15% by mass or more of an unsaturated fatty acid having 18 carbon atoms, and still more preferably a vegetable oil and contains 20% by mass or more of an unsaturated fatty acid having 18 carbon atoms.

In addition, the glycerin fatty acid ester in the oil or fat composition for food preparation is more preferably a vegetable oil and contains 15% by mass or more of an unsaturated fatty acid having 18 carbon atoms, still more preferably a vegetable oil and contains 20% by mass or more of an unsaturated fatty acid having 18 carbon atoms in the total fatty acids of the glycerin fatty acid ester, even still more preferably a vegetable oil and contains 31% by mass or more of an unsaturated fatty acid having 18 carbon atoms in the total fatty acids of the glycerin fatty acid ester, even further still more preferably a vegetable oil and contains 35% by mass or more of an unsaturated fatty acid having 18 carbon atoms in the total fatty acids of the glycerin fatty acid ester, and even further still more preferably a vegetable oil and contains 40% by mass or more of an unsaturated fatty acid having 18 carbon atoms in the total fatty acids of the glycerin fatty acid ester.

In the glycerin fatty acid ester in the oil or fat composition for food preparation of the present embodiment, from the viewpoint of cooking suitability and processing suitability to a powdered oil or fat, the content of the saturated fatty acid (SFA) in the total fatty acids of the glycerin fatty acid ester is preferably 5% by mass or more and more preferably 10% by mass or more, and is preferably 100% by mass or less, more preferably 80% by mass or less, still more preferably 70% by mass or less, even still more preferably 65% by mass or less, even further still more preferably 60% by mass or less, even further still more preferably 50% by mass or less, and even further still more preferably 45% by mass or less.

In the glycerin fatty acid ester in the oil or fat composition for food preparation of the present embodiment, from the viewpoint of cooking suitability and processing suitability to a powdered oil or fat, the content of the polyunsaturated fatty acid (PUFA) in the total fatty acids of the glycerin fatty acid ester is preferably 0% by mass or more, more preferably 5% by mass or more, still more preferably 7% by mass or more, and even still more preferably 10% by mass or more, and is preferably 95% by mass or less, more preferably 80% by mass or less, still more preferably 70% by mass or less, and even still more preferably 60% by mass or less.

The first embodiment and the second embodiment are exemplified as typical use applications of the oil or fat composition for food preparation, but the oil or fat composition for food preparation of the present embodiment may be used for other use applications. The oil or fat composition for food preparation of the present embodiment may be used, for example, for the above-described (iii) to (iv) or may be used in combination of the respective use applications.

### (Food)

The food of the present embodiment contains the oil or fat composition for food preparation of the present embodiment.

The obtained food is preferably cooked food, and can also be used for the preparation of oil or fat processed foods such as chocolate, margarine (however, puff pastry margarine is excluded), shortening, fat spread, and ice cream, in addition to fried foods, noodles, stir-fried food, and dressing or mayonnaise, as described above. In addition, the obtained food can also be used for dressed salads, rices, seasonings, confectioneries (gummies, chewing gums, candies, tablet candies, ice cream, and the like), breads, and the like. In addition, the composition can also be used for beverages such as milk, soy milk, a milk beverage, a lactic acid beverage, a refreshing beverage, tea, and coffee. Since the food of the present embodiment contains the oil or fat composition for food preparation of the present embodiment, the food has a good flavor and texture, and also has good physical properties such as noodle anti-sticking property and emulsification stability.

When the oil or fat composition for food preparation of the present embodiment is used for preparing margarine, from the viewpoint of improving processing suitability and flavor of margarine, it is preferable that the oil or fat composition for food preparation further contains an oil or fat other than the oil or fat composition for food preparation of the present embodiment.

In addition, examples of the food of the present embodiment also include supplements (tablets (including uncoated tablets, sugar-coated tablets, effervescent tablets, film-coated tablets, chewable tablets, troches, and the like), round tablets, capsules (hard capsules, soft capsules, seamless capsules, and the like), granules, powders, liquids, syrups, jellies, candies, gummies, and the like), food for elderly people (beverages, gel-like foods, and the like), and proteins. Since these foods contain the oil or fat composition for food preparation of the present embodiment, the foods have good flavor and texture.

### (Powdered Oil or Fat)

The powdered oil or fat of the present embodiment contains the oil or fat composition for food preparation of the present embodiment. Since the powdered oil or fat of the present embodiment contains the oil or fat composition for food preparation of the present embodiment, the powdered oil or fat has excellent powder fluidity and emulsification stability, and has a good flavor.

The powdered oil or fat includes an oil-in-water droplet type dry emulsion powdered oil or fat obtained by drying an oil-in-water droplet type emulsion and a full-fat type powdered oil or fat obtained by powdering a high melting point oil or fat. The powdered oil or fat of the present embodiment may be any of the above-described powder oils or fats, but preferably includes an oil-in-water droplet type dry emulsion powdered oil or fat.

The content of the oil or fat composition for food preparation in the powdered oil or fat is preferably 10% by mass or more, more preferably 20% by mass or more, still more preferably 25% by mass or more, even still more preferably 30% by mass or more, and even further more preferably 35% by mass or more, and is, for example, 100% by mass or less, and may be 90% by mass or less, may be 80% by mass or less, may be 70% by mass or less, or the like.

### (Oil-In-Water Droplet Type Dry Emulsion Powdered Oil or Fat)

In the present embodiment, the oil-in-water droplet type dry emulsion powdered oil or fat preferably contains an excipient. The excipient mainly forms a powdered oil or fat by coating the oil or fat component, and further prevents the oil or fat component from bleeding out. Such an excipient is not limited, and in general, an excipient used in a case of producing a powdered oil or fat can be used. Examples thereof include sugars such as starch (octenyl succinic acid starch and the like), syrup, powdered syrup, corn syrup, sucrose, glucose, maltose, lactose, fructose, galactose, trehalose, dextrin, sodium alginate, and carrageenan; sugar alcohols such as erythritol, sorbitol, mannitol, maltitol, lactitol, reduced palatinose, and reduced starch syrup; wheat flour; proteins such as gelatin, acid casein, and sodium casein; and gums such as xanthan gum, guar gum, gum arabic, and tragacanth gum. The excipient may be used in one kind alone or in combination of two or more kinds thereof.

The excipient is preferably one kind or two or more kinds selected from the group consisting of sugars, gum, and proteins, and more preferably one kind or two or more kinds selected from the group consisting of octenyl succinate starch, corn syrup, dextrin, gum arabic, acid casein, and sodium caseinate.

In the present embodiment, the median diameter of fat globules (oil droplet globules) of the oil-in-water droplet type dry emulsion powdered oil or fat is preferably 0.05 μm or more, more preferably 0.1 μm or more, and still more preferably 0.15 μm or more, and is preferably 10 μm or less, more preferably 5 μm or less, still more preferably 3 μm or less, and even still more preferably 2 μm or less. The method of measuring the median diameter of the fat globules is described in the section of Examples.

### (Method for Producing Oil-In-Water Droplet Type Dry Emulsion Powdered Oil or Fat)

In the present embodiment, the above-described oil-in-water droplet type dry emulsion powdered oil or fat is obtained through the following steps (a) to (c). Each of the steps (a) to (c) will be described in detail.
(a) a step of obtaining a mixture containing edible oil or fat, water, and excipient
(b) a step of emulsifying the mixture to obtain an oil-in-water droplet type emulsion
(c) a step of drying the emulsion

In the step (a), water is mixed with a total of 100 parts by mass of the edible oil or fat and the excipient, preferably 30 parts by mass or more, more preferably 40 parts by mass or more, and preferably 300 parts by mass or less, and more preferably 200 parts by mass or less to prepare a mixture. In addition, the step (a) preferably includes the following steps (a)-1 to (c)-3.
(a)-1: a step of mixing excipient with water to obtain a water phase raw material
(a)-2: a step of mixing edible oil or fat with an emulsifier optionally to obtain an oil phase raw material
(a)-3: a step of mixing the water phase raw material and the oil phase raw material to obtain a mixture

In the step (b), a known method can be used, and for example, the mixture is subjected to an emulsification treatment with a homogenizer, a homomixer, a high-pressure emulsifier, a high-pressure homogenizer, a colloid mill, or the like to obtain an oil-in-water droplet type emulsion.

In the step (c), a known method can be used, and for example, the emulsion is dried using a vacuum dryer, a vacuum freeze dryer, a vacuum belt dryer, a vacuum drum dryer, a spray dryer, or the like.

### (Method for Producing Full-Fat Type Powdered Oil or Fat)

In the present embodiment, the above-described full-fat type powdered oil or fat is obtained by a step of powdering edible oil or fat through spray cooling or cooling pulverization. In the above-described step, a known method can be used, and for example, spray cooling or cooling pulverization is performed using a spray dryer or the like.

### (Method for Producing Oil or Fat Composition for Food Preparation)

The method for producing an oil or fat composition for food preparation of the present embodiment may include a step of reacting a fatty acid having 13 or more and 15 or less carbon atoms with glycerin to produce a glycerin fatty acid ester. In the above-described step, by formulating a fatty acid having 13 or more and 15 or less carbon atoms at any content to produce the glycerin fatty acid ester, it is possible to adjust the fatty acid composition of the entire oil or fat composition for food preparation to any composition. As the fatty acid having 13 or more and 15 or less carbon atoms, in addition to commercially available food additives and reagents, a fatty acid obtained by saponifying natural animal and vegetable oils or a fatty acid obtained by subjecting the fatty acid to molecular distillation as necessary can be used. In a case of producing a glycerin fatty acid ester containing a fatty acid residue having 13 or more and 15 or less carbon atoms using a natural animal and vegetable oil, since the natural animal and vegetable oil may contain a fatty acid having 13 or more and 15 or less carbon atoms and at the same time a fatty acid having 12 carbon atoms, the glycerin fatty acid ester can be produced using a fatty acid having 13 or more and 15 or less carbon atoms. Therefore, it is easy to adjust the mass ratio of the content of the fatty acid having 12 carbon atoms with respect to the content of the fatty acid having 13 or more and 15 or less carbon atoms in the total fatty acids of the glycerin fatty acid ester.

In addition, the method for producing an oil or fat composition for food preparation of the present embodiment may further include a step of subjecting the glycerin fatty acid ester obtained as described above to a transesterification with an edible oil or fat containing a glycerin fatty acid ester other than the glycerin fatty acid ester. As a result, when the oil or fat composition for food preparation is in a liquid state, the liquid state can be more easily maintained. In addition, when the oil or fat composition for food preparation is used for preparing a powdered oil or fat, the processing suitability for the powdered oil or fat is improved.

The edible oil or fat containing a glycerin fatty acid ester other than the glycerin fatty acid ester is not particularly limited. Examples thereof include vegetable oils or fats such as rapeseed oil, soybean oil, corn oil, sesame oil, coconut oil, palm oil, palm kernel oil, rice oil, cottonseed oil, safflower oil, sunflower oil, olive oil, linseed oil, peanut oil, sal fat, cacao butter, and shea butter; animal oils or fats such as beef tallow, pork fat, chicken fat, milk fat, and fish oil; and synthetic oils or fats such as medium-chain fatty acid triglycerides. In addition, examples thereof include processed oils or fats obtained by subjecting the above-described oils or fats to treatments such as separation and hydrogenation. Among these, one kind or two or more kinds selected from the group consisting of vegetable oils or fats and processed oils or fats thereof are preferable, and one kind or two or more kinds selected from the group consisting of rapeseed oil, soybean oil, palm oil, sunflower oil, and processed oils or fats thereof are more preferable.

In the method for producing the transesterified oil, the transesterification can be performed by a known method. The method of the transesterification may be random transesterification or transesterification specific to a fatty acid bonded to positions 1 and 3 of glycerol, but random transesterification is preferable. In addition, examples of the catalyst used for the transesterification include a chemical catalyst such as sodium methoxide and an enzyme catalyst such as lipase.

The method for producing a transesterified oil can be performed, for example, by the following method.

0.3 parts by mass of sodium methoxide is added as a catalyst to 100 parts by mass of a mixed oil obtained by mixing the obtained glycerin fatty acid ester with edible oils or fats containing glycerin fatty acid esters other than the glycerin fatty acid ester, and a random transesterification reaction is performed under the conditions of 80° C. and a degree of vacuum of 2.0 kPa for 60 minutes while stirring. After the random transesterification reaction, the catalyst is removed by washing with water. After washing with water, a decolorization treatment is performed using activated clay, and a deodorization treatment is further performed to obtain each transesterified oil.

### (Method for Preparing Food)

The method for preparing food of the present embodiment includes a step of preparing food using the oil or fat composition for food preparation of the present embodiment.

The method for preparing food is not limited, and examples thereof include heat cooking, preparation of dressed salad, dressing, and mayonnaise, preparation of oil or fat processed foods such as margarine, and preparation of powdered oil or fat. In addition, examples of the method for preparing food include preparation of confectionery and bread.

Since the oil or fat composition for food preparation of the present embodiment is used, the food preparation method of the present embodiment is easy to prepare food and has excellent processing suitability to a powdered oil or fat and the like.

### (Method for Cooking Food)

The method for cooking food of the present embodiment includes a step of cooking food using the oil or fat composition for food preparation of the present embodiment.

The method for cooking food is not limited, and examples thereof include baking, boiling, heating with microwave, steaming, steaming and convection heating, heat cooking such as oiling, preparing dressed salad, dressing, or mayonnaise, and the like. In addition, examples of the method for cooking food include rice cooking.

Since the oil or fat composition for food preparation of the present embodiment is used, the method for cooking food of the present embodiment can be preferably used for heat cooking such as frying and stir-frying since fuming during heat cooking can be suppressed, and has excellent cooking suitability in terms of suppressing burning in stir-frying cooking. Furthermore, the texture and flavor of the food can be improved. In addition, in cooking other than heat cooking, effects such as improvement of looseness and texture of noodles and improvement of emulsification stability of mayonnaise or the like can be obtained. In addition, the composition can be used as an anti-sticking oil for rice cooking, and an effect of improving the dispersibility of the oil or fat during rice cooking can be obtained.

### (Method for Improving Quality of Food)

The method for improving the quality of food of the present embodiment includes a step of preparing food using the oil or fat composition for food preparation of the present embodiment. Since the oil or fat composition for food preparation of the present embodiment is the same as the above-described oil or fat composition for food preparation, the description thereof will not be repeated.

According to the method for improving the quality of food of the present embodiment, it is possible to improve the flavor and texture of the cooked food, and improve the quality such as the emulsifying properties and the emulsification stability of the powdered oil or fat, and the emulsification stability of oil or fat processed foods such as margarine and chocolate.

### (Method for Improving Quality of Cooked Food)

The method for improving the quality of cooked food of the present embodiment includes a step of preparing food using the oil or fat composition for food preparation of the present embodiment. Since the oil or fat composition for food preparation of the present embodiment is the same as the above-described oil or fat composition for food preparation, the description thereof will not be repeated.

According to the method for improving the quality of cooked food of the present embodiment, it is possible to improve the quality of the obtained cooked food, such as the texture, the flavor, the looseness of noodles, the suppression of burning, and the emulsification stability.

Although the embodiments of the present invention have been described above, these are examples of the present invention, and various configurations other than the above can be adopted.

In addition, the present invention is not limited to the above-described embodiments, and modifications, improvements, and the like within a range in which the object of the present invention can be achieved are included in the present invention.

Hereinafter, examples of the reference forms will be added.
[1]

An oil or fat composition for food preparation containing:
a glycerin fatty acid ester containing a fatty acid residue having 13 or more and 15 or less carbon atoms,
in which the oil or fat composition for food preparation contains 1.8% by mass or more and 100% by mass or less of a fatty acid having 13 or more and 15 or less carbon atoms in total fatty acids of the glycerin fatty acid ester, and
in the total fatty acids of the glycerin fatty acid ester, a content of a fatty acid having 12 carbon atoms is 0 or more and 2.5 or less in terms of a mass ratio with respect to a content of the fatty acid having 13 or more and 15 or less carbon atoms (excluding an oil or fat composition for preparation of puff pastry margarine, and the oil or fat composition for food preparation that is milk fat, beef tallow, mutton tallow, ucuuba butter, murumuru butter, euglena oil, or margarine).
[2]

The oil or fat composition for food preparation according to [1],
in which the fatty acid having 13 or more and 15 or less carbon atoms includes one kind or two or more kinds selected from the group consisting of tridecanoic acid, tetradecanoic acid, and pentadecanoic acid.
[3]

The oil or fat composition for food preparation according to [1] or [2],
in which in the total fatty acids of the glycerin fatty acid ester, the content of the fatty acid having 12 carbon atoms is 0% by mass or more and 15% by mass or less.
[4]

The oil or fat composition for food preparation according to [1] or [2],
in which in the total fatty acids of the glycerin fatty acid ester, a content of a fatty acid having 14 carbon atoms is 1.5% by mass or more and 100% by mass or less.
[5]

The oil or fat composition for food preparation according to [1] or [2],
in which the glycerin fatty acid ester contains a transesterified oil.
[6]

The oil or fat composition for food preparation according to [1] or [2],
in which the oil or fat composition for food preparation is used for cooking.
[7]

The oil or fat composition for food preparation according to [6],
in which the oil or fat composition for food preparation is used for one kind selected from the group consisting of frying oil, coating oil, anti-sticking oil for noodles, stir-frying oil, and oil for raw use.
[8]

The oil or fat composition for food preparation according to [1] or [2],
in which the oil or fat composition for food preparation is used for preparing a powdered oil or fat.
[9]

Food containing:
the oil or fat composition for food preparation according to [1] or [2].
[10]

A powdered oil or fat containing:
the oil or fat composition for food preparation according to [1] or [2].
[11]

A method for producing an oil or fat composition for food preparation according to [1] or [2], the method including:
a step of reacting a fatty acid having 13 or more and 15 or less carbon atoms with glycerin to produce a glycerin fatty acid ester.
[12]

The method for producing an oil or fat composition for food preparation according to [11], further including:
a step of subjecting the glycerin fatty acid ester obtained by reacting the fatty acid having 13 or more and 15 or less carbon atoms with the glycerin to a transesterification with an edible oil or fat containing a glycerin fatty acid ester other than the glycerin fatty acid ester.
[13]

A method for preparing food, including:
a step of preparing food using the oil or fat composition for food preparation according to [1] or [2].
[14]

A method for cooking food, including:
a step of cooking food using the oil or fat composition for food preparation according to [1] or [2].
[15]

A method for improving quality of food, including:
a step of preparing food using the oil or fat composition for food preparation according to [1] or [2].
[16]

A method for improving quality of cooked food, including:
a step of cooking food using the oil or fat composition for food preparation according to [1] or [2].

### EXAMPLES

Examples of the present invention are shown below, but the scope of the present invention is not limited thereto.

In the following examples, the unit of formulation is part by mass unless otherwise specified.

The following raw materials were used as raw materials of the oil or fat. The oil or fat of each example was formulated according to Tables 1, 2, and 4. In addition, the transesterified oil was produced according to the following <Method for producing transesterified oil >.
Soybean oil: soybean white pressed oil NS, manufactured by J-Oil Mills Ltd.
Rapeseed oil: AJINOMOTO SARASARA Canola Oil, manufactured by J-Oil Mills, Inc.
High oleic sunflower oil (high oleic acid sunflower oil): manufactured by J-Oil Mills Co., Ltd.
Palm kernel oil: manufactured by J-Oil Mills Co., Ltd.
coconut oil: manufactured by J-Oil Mills Co., Ltd.
Palm olein: Palm Olein IV67, manufactured by J-Oil Mills Co., Ltd.
Palm kernel extreme hard oil: manufactured by J-Oil Mills Co., Ltd.
Glyceryl tritetradecanoate: one of Production Example 1 was used
Glyceryl tritridecanoate: one of Production Example 1 was used
Glyceryl tripentadecanoate: one of Production Example 1 was used
MCT: MCT-1, manufactured by J-Oil Mills Co., Ltd.
Linseed oil: AJINOMOTO AMANO OIL, manufactured by J-Oil Mills, Ltd.

### Production Example 1: Method for Producing Glyceryl Tritetradecanoate, Glyceryl Tritridecanoate, and Glyceryl Tripentadecanoate

0.1 parts by mass of sodium hydroxide was added as a catalyst to a mixture of 89.7 parts by mass of myristic acid (tetradecanoic acid) (manufactured by FUJIFILM Wako Pure Chemical Corporation) and 10.3 parts by mass of glycerin (manufactured by FUJIFILM Wako Pure Chemical Corporation), and the mixture was stirred for 240 minutes while blowing nitrogen under the conditions of 220° C. and atmospheric pressure to perform an ester synthesis reaction. After the ester synthesis reaction, a sodium hydroxide aqueous solution was added to carry out deacidification, and unreacted tetradecanoic acid was removed. After deacidification, a decolorization treatment was performed using activated clay, and a deodorization treatment was further performed to obtain glyceryl tritetradecanoate.

The methods for producing glyceryl tritridecanoate and glyceryl tripentadecanoate were performed in the same manner as the method for producing glyceryl tritetradecanoate, except that in the above-described method for producing glyceryl tritetradecanoate, the tetradecanoic acid was changed to tridecanoic acid (manufactured by Tokyo Chemical Industry Co., Ltd.) or pentadecanoic acid (manufactured by Tokyo Chemical Industry Co., Ltd.).

### <Method for Producing Transesterified Oil>

0.3 parts by mass of sodium methoxide was added as a catalyst to 100 parts by mass of a mixed oil obtained by mixing the respective oils or fats according to the transesterified oil formulation of Tables 1 to 3 and 5 (the unit is part by mass), and a random transesterification reaction was performed under the conditions of 80° C. and a degree of vacuum of 2.0 kPa for 60 minutes while stirring. After the random transesterification reaction, the catalyst was removed by washing with water. After washing with water, a decolorization treatment was performed using activated clay, and a deodorization treatment was further performed to obtain each transesterified oil.

### <Analysis of Fatty Acid Content in Glycerin Fatty Acid Ester>

The oil or fat of each example was converted into a fatty acid methyl ester by a boron trifluoride methanol method, and then the fatty acid composition was analyzed by a gas chromatography (GC) method under the following conditions, and the content (% by mass) of each fatty acid in the entire fatty acid was calculated. In the table, for example, “C8:0” represents a fatty acid having 8 carbon atoms and 0 unsaturated bonds, and “C18:1” represents a fatty acid having 18 carbon atoms and 1 unsaturated bond. In addition, from the obtained results, the content of the fatty acid having 13 or more and 15 or less carbon atoms and the mass ratio of the content of the fatty acid having 12 carbon atoms with respect to the content of the fatty acid having 13 or more and 15 or less carbon atoms in the total fatty acids of the glycerin fatty acid ester, the unsaturated fatty acid having 18 carbon atoms, the saturated fatty acid (SFA), and the polyunsaturated fatty acid (PUFA) were calculated. The results are shown in Tables 1, 2, and 4 to 6.
GC device: product name GC2010 (manufactured by Shimadzu Corporation)
Column: SP-2560 (100 m×0.25 mm×0.2 μm) (manufactured by SPELCO)
Injection port temperature: 250° C.
Carrier gas: helium (29.1 ml/min)·
Split ratio: 25:1
Column temperature: 180° C. 55 min→(8° C./min)→220° C. 5 min
Detector: hydrogen flame ion detector (260° C.)

### <Iodine Value>

For the oil or fat of each example, the iodine value was measured according to “Standard Methods for the Analysis of Fats, Oils and Related Materials 2.3.4.1-1996 Iodine Value (Wijs-Cyclohexane Method)” (The Japan Oil Chemists' Society).

### Heating Test (Control Example 1, Examples 1 to 9, and Comparative Examples 1 to 5

2 g of the oil or fat of each example was weighed into a stainless steel petri dish having an inner diameter of 50 mm and a height of approximately 14 mm and placed on a hot plate (“EC-1200N”, manufactured by AS ONE Corporation) at a set temperature of 220° C. for 2 hours. The measured temperature of the heated oil or fat was 180° C. The presence or absence of fuming from the oil or fat was observed while heating. In addition, in the oil or fat in which fuming was observed, fuming was observed after the start of heating for about 15 to 20 minutes. The acid value of the oil or fat after heating for 2 hours was measured according to “Standard Methods for the Analysis of Fats, Oils and Related Materials 2.3.1 Acid Value” (The Japan Oil Chemists' Society). The results are shown in Table 1.

TABLE 1

| | | Control | | | | | | |
|---|---|---|---|---|---|---|---|---|
| | | Example | Comparative | Comparative | Comparative | Comparative | Comparative | Example |
| | | 1 | Example 1 | Example 2 | Example 3 | Example 4 | Example 5 | 1 |
| Formulation | Soybean oil | 100 | | | 33.3 | 33.3 | | |
| (parts by mass) | Palm kernel oil | | 100 | | 66.7 | | | |
| | Coconut oil | | | 100 | | 66.7 | | |
| | Transesterified oil | | | | | | | 100 |
| | Glyceryl | | | | | | | |
| | tritetradecanoate | | | | | | | |
| | MCT | | | | | | | |
| | Palm kernel extreme hard | | | | | | 100 | |
| | oil | | | | | | | |
| Transesterified | Soybean oil | | | | | | | 84.2 |
| oil formulation | Glyceryl | | | | | | | 15.8 |
| (parts by mass) | tritetradecanoate | | | | | | | |
| Fatty acid content | C8:0 | | 3.4 | 7.1 | 2.3 | 4.7 | 3.4 | |
| (% by mass) | C10:0 | | 3.1 | 5.6 | 2.1 | 3.7 | 3.1 | |
| | C12:0 | | 47.9 | 48.0 | 32.0 | 32.0 | 47.9 | |
| | C14:0 | 0.1 | 16.1 | 18.4 | 10.7 | 12.3 | 16.1 | 15.8 |
| | C16:0 | 10.2 | 8.4 | 9.3 | 9.0 | 9.6 | 8.4 | 8.7 |
| | C16:1 | 0.1 | | | | | | 0.1 |
| | C18:0 | 3.8 | 2.2 | 2.7 | 2.7 | 3.1 | 20.7 | 3.2 |
| | C18:1 | 24.8 | 16.1 | 6.9 | 19.0 | 12.8 | | 21.1 |
| | C18:2 | 52.8 | 2.5 | 1.6 | 19.2 | 18.6 | | 45.0 |
| | C18:3 | 6.2 | | | 2.1 | 2.1 | | 5.3 |
| | C20:0 | 0.3 | | | 0.1 | 0.1 | | 0.3 |
| | C20:1 | 0.2 | | | 0.1 | 0.1 | | 0.2 |
| | C22:0 | 0.4 | | | 0.1 | 0.1 | | 0.3 |
| C13:0 to C15:0 | | 0.1 | 16.1 | 18.4 | 10.7 | 12.3 | 16.1 | 15.8 |
| C12:0/C13:0 to C15:0 | | 0.0 | 3.0 | 2.6 | 3.0 | 2.6 | 3.0 | 0.0 |
| C18 unsaturated fatty acid | | 83.8 | 18.5 | 8.5 | 40.3 | 33.5 | 0.0 | 71.4 |
| Saturated fatty acid (SFA) | | 14.8 | 81.1 | 91.0 | 59.0 | 65.6 | 99.6 | 28.3 |
| Polyunsaturated fatty acid (PUFA) | | 59.0 | 2.5 | 1.6 | 21.3 | 20.7 | 0.0 | 50.3 |
| Iodine value | | 129.3 | 18.1 | 8.7 | 55.1 | 48.8 | 0.0 | 110.1 |
| Heating test | Presence or absence of | Absent | Present | Present | Present | Present | Present | Absent |
| | fuming | | | | | | | |
| | Acid value | 1.64 | 6.01 | 6.25 | 2.68 | 2.99 | 7.45 | 0.57 |

| | | Example 2 | Example 3 | Example 4 | Example 5 | Example 6 | Example 7 | Example 8 | Example 9 |
|---|---|---|---|---|---|---|---|---|---|
| Formulation | Soybean oil | | 91 | 87 | 81 | 78 | 73 | 82 | 85 |
| (parts by mass) | Palm kernel oil | | 5 | 10 | 16 | 20 | 25 | 10 | |
| | Coconut oil | | | | | | | | |
| | Transesterified oil | 100 | | | | | | | |
| | Glyceryl | | 4 | 3 | 3 | 2 | 2 | 8 | 10 |
| | tritetradecanoate | | | | | | | | |
| | MCT | | | | | | | | 5 |
| | Palm kernel extreme hard | | | | | | | | |
| | oil | | | | | | | | |
| Transesterified | Soybean oil | 28.2 | | | | | | | |
| oil formulation | Glyceryl | 71.8 | | | | | | | |
| (parts by mass) | tritetradecanoate | | | | | | | | |
| Fatty acid content | C8:0 | | 0.2 | 0.3 | 0.5 | 0.7 | 0.8 | 0.3 | 4.3 |
| (% by mass) | C10:0 | | 0.2 | 0.3 | 0.5 | 0.6 | 0.8 | 0.3 | 0.7 |
| | C12:0 | | 2.4 | 4.8 | 7.7 | 9.6 | 12.0 | 4.8 | |
| | C14:0 | 71.8 | 4.9 | 4.7 | 5.6 | 5.3 | 6.1 | 9.7 | 10.1 |
| | C16:0 | 2.9 | 9.7 | 9.7 | 9.6 | 9.6 | 9.6 | 9.2 | 8.7 |
| | C16:1 | | 0.1 | 0.1 | 0.1 | 0.1 | 0.1 | 0.1 | 0.1 |
| | C18:0 | 1.1 | 3.5 | 3.5 | 3.4 | 3.4 | 3.3 | 3.3 | 3.2 |
| | C18:1 | 7.1 | 23.4 | 23.2 | 22.7 | 22.6 | 22.1 | 21.9 | 21.1 |
| | C18:2 | 15.0 | 48.2 | 46.2 | 43.2 | 41.7 | 39.2 | 43.5 | 44.9 |
| | C18:3 | 1.8 | 5.6 | 5.4 | 5.0 | 4.8 | 4.5 | 5.1 | 5.3 |
| | C20:0 | 0.1 | 0.3 | 0.3 | 0.3 | 0.3 | 0.3 | 0.3 | 0.3 |
| | C20:1 | 0.1 | 0.2 | 0.2 | 0.2 | 0.2 | 0.2 | 0.2 | 0.2 |
| | C22:0 | 0.1 | 0.4 | 0.4 | 0.3 | 0.3 | 0.3 | 0.3 | 0.3 |
| C13:0 to C15:0 | | 71.8 | 4.9 | 4.7 | 5.6 | 5.3 | 6.1 | 9.7 | 10.1 |
| C12:0/C13:0 to C15:0 | | 0.0 | 0.5 | 1.0 | 1.4 | 1.8 | 2.0 | 0.5 | 0.0 |
| C18 unsaturated fatty acid | | 23.9 | 77.2 | 74.8 | 70.8 | 69.1 | 65.8 | 70.6 | 71.2 |
| Saturated fatty acid (SFA) | | 76.0 | 21.5 | 24.0 | 28.0 | 29.8 | 33.1 | 28.2 | 27.6 |
| Polyunsaturated fatty acid (PUFA) | | 16.8 | 53.8 | 51.6 | 48.2 | 46.5 | 43.7 | 48.6 | 50.2 |
| Iodine value | | 36.8 | 118.5 | 114.3 | 107.6 | 104.4 | 98.9 | 107.8 | 109.9 |
| Heating test | Presence or absence of | Absent | Absent | Absent | Absent | Absent | Absent | Absent | Absent |
| | fuming | | | | | | | | |
| | Acid value | 2.03 | 2.00 | 1.62 | 1.94 | 2.04 | 2.10 | 1.81 | 1.90 |

As shown in Table 1, in Comparative Examples, fuming was observed, whereas in Examples, fuming was not observed.

### Cooking Evaluation (Control Examples 1 to 3 and Examples 10 to 25)

Regarding the oils or fats of each example, evaluation of frying oil, evaluation of coating oil, evaluation of anti-sticking oil for noodles, evaluation of stir-frying oil, and evaluation of mayonnaise were performed as follows. When the control example was used as a standard for each evaluation, Control Example 2 was used as a standard for Examples 10 to 22, Control Example 1 was used as a standard for Examples 23 and 24, and Control Example 3 was used as a standard for Example 25.

The results are shown in Table 2.

(Evaluation of frying oil)
1. 200 g of a mix powder (donut ball mix, manufactured by NIHON SHOKKEN HOLDINGS CO., LTD.) was added to 60 g of water, and the mixture was mixed by hand until the dough comes together.
2. 10 g of the dough of 1. was molded into a circle.
3. The oil or fat of each example was put into a stainless steel pot having a diameter of 15 cm, heated to 170° C. with an electric heater, and the dough of 2. was fried for 2 minutes and 30 seconds to obtain a donut.

The donut obtained above was eaten by four expert panelists, and oiliness, oily odor of the base oil, and texture (crispiness) were evaluated based on the following evaluation criteria. An average value of the scores of the expert panelists was defined as the evaluation point. The control example was evaluated as 3.0 points, and 3.0 points or more was considered acceptable.

(Evaluation criteria)

### (Oiliness)

5: very light
4: light
3: slightly light
2: slightly rich
1: rich

### (Oily Odor of Base Oil)

5: no odor at all
4: almost no odor
3: not much odor
2: a slight odor
1: an excessive odor

### (Texture (Crispiness))

5: very crispy
4: crispy
3: slightly crispy
2: not very crispy
1: not crispy at all

### (Evaluation of Coating Oil)

1. 4 g (2% with respect to the weight of boiled pasta) of the oil or fat of each example was weighed in a bowl.
2. Hot water was boiled in a 7 L pot, the hot water was prepared to 5 kg (1 kg/100 g of dry pasta), and 50 g (1% with respect to the hot water) of salt was added immediately before the pasta was put in.
3. 500 g of pasta (Ma-Ma, 1.8 mm, manufactured by Nissin Foods Holdings Co., Ltd.) was put in and boiled for 11 minutes.
4. The boiled pasta in 3. was cooled with running water for 1 minute, drained, and allowed to stand for about 3 minutes. In this case, the noodles were not touched by hand as much as possible so that the noodle skin was not damaged.
5. 200 g of the pasta of 4. was weighed in the bowl of 1, and mixed for 30 seconds.
6. The pasta was transferred to a plate and stored in a refrigerator at 4° C. for 24 hours.
7. The pasta after refrigerated storage was heated in a microwave at 800 W for 1 minute and evaluated.

The pasta obtained above was eaten by four expert panelists, and the hardness and the stickiness were evaluated based on the following evaluation criteria. An average value of the scores of the expert panelists was defined as the evaluation point. The control example was evaluated as 0 points, and 0 points or more was considered acceptable.

### (Evaluation Criteria)

### (Hardness)

2: The balance between hardness and softness is very good, and the crispness and elasticity are extremely preferable
1: The balance between hardness and softness is good, and the crispness and elasticity are preferable
0: The balance between hardness and softness is slightly good, and the crispness and elasticity are slightly preferable
−1: The balance between hardness and softness is poor
−2: The balance between hardness and softness is extremely poor

### (Stickiness)

2: not cut into pieces when bitten, and has extremely preferable stickiness and firmness
1: not cut into pieces when bitten, and has preferable stickiness and firmness
0: not cut into pieces when bitten, and has slightly preferable stickiness and firmness
−1: cut into pieces when bitten, and has little stickiness and firmness
−2: cut into pieces when bitten, and has no stickiness and firmness

### (Evaluation of Anti-Sticking Oil for Noodles)

1. 2.7 g (1.8% with respect to the weight of boiled Chinese noodle) of the oil or fat of each example was weighed in a bowl.
2. 500 g of raw Chinese noodles (Sapporo raw ramen from Hokkaido, manufactured by Kikusui Seisakusho Co., Ltd.) was boiled in 5.0 kg of hot water for 3 minutes.
3. The Chinese noodle boiled in 2. was cooled with running water for 1 minute. At this time, the noodles were not allowed to touch as little as possible so that the noodle skin was not rough.
4. The Chinese noodle of 3. was placed in a colander and allowed to stand for 5 minutes.
5. 150 g of the Chinese noodle of 4. was weighed in the bowl of 1, and mixed up and down for 30 seconds.
6. The Chinese noodle of 5. was put in a container, and a lid that could be closely attached was put on the container. A weight of twice the noodle weight (300 g) was placed on the lid.
7. The Chinese noodle was stored in a refrigerator at 4° C. for 24 hours.
8. The Chinese noodle of 7. was moved left and right with chopsticks to loosen, and the time (seconds) taken to loosen was measured. The ratio of the time (seconds) of the oil or fat of each example with respect to the time (seconds) of the control example was calculated for the time taken for the separating.

### (Evaluation of Stir-Frying Oil)

1. 240 g of rice (Sato rice, manufactured by Sato Food Co., Ltd.) was mixed with 48 g of sauce (Bulldog medium thick sauce, manufactured by Bulldog Sauce Co., Ltd.) and 24 g of water, divided into 65 g portions, and cooled to room temperature to obtain sauce rice.
2. The sauce rice of 1. was heated in a microwave at 800 W for 20 seconds, slightly loosened, and placed on a rice scoop.
3. 1.5 g of the oil or fat of each example was put into a frying pan of which the weight was measured in advance, and the frying pan was heated with an IH heater (firepower: medium) until the center temperature of the oil or fat reached 170° C. while the oil was spread with a spatula.
4. After the oil or fat reached the temperature of 170° C., 10 seconds later, the sauce rice of 2. was added to the frying pan, and the frying pan surface was spread with a spatula to cover the frying pan surface evenly.
5. After adding the sauce rice, the rice was stir-fried with a spatula for 1.5 minutes by pressing the rice, and then the heating was terminated.
6. The frying pan was turned over for 3 seconds, and the rice that had not been burned was dropped, and the weight (g) of the sauce rice remaining on the surface of the frying pan was measured. In addition, the surface of the frying pan was imaged.
7. The residual rate (%) of the sauce rice remaining in the frying pan was measured. The ratio of the residual rate (%) of the oil or fat in each example with respect to the residual rate (%) of the oil or fat in the control example was calculated.

### (Evaluation of Mayonnaise)

1. 50 g of the oil or fat of each example, 14 g of egg yolk, 5 g of vinegar, and 1 g of salt were weighed.
2. The egg yolk and salt were uniformly mixed, and vinegar was added thereto.
3. After mixing until the lumps disappeared, the oil or fat were added little by little, and the mixture was stirred after a little oil was added. This was repeated.
4. After all the oils or fats were put in, the emulsifying properties of the mayonnaise were evaluated according to the criteria described later.
5. The mixture was stirred until the horn was formed.
6. The mixture was placed in a plastic cup and stored in a refrigerator at 4° C. for 24 hours.

Regarding the emulsifying properties, in the method for producing mayonnaise, the emulsifying properties were evaluated after the step of 3. was completed. In addition, in the method for producing mayonnaise, the emulsification stability was evaluated after the step of 6. was completed. Both the emulsifying properties and the emulsification stability were evaluated according to the following evaluation criteria. The score was determined by the consensus of four expert panelists. The control example was evaluated as 5 points, and 3 points or more was considered acceptable.

### (Evaluation Criteria)

### (Emulsifying Properties and Emulsification Stability)

5: moisture and oil were not separated at all
4: moisture and oil were not substantially separated
3: moisture and oil were slightly separated, but were within an acceptable range
2: moisture and oil were separated
1: moisture and oil were considerably separated

### (Evaluation of Anti-Sticking Oil for Rice Cooking)

1. Oil or fat of each example was colored by adding carotene so that the concentration was set to 18 by mass.
2. 400 g of raw rice was weighed and washed in a colander (the water was replaced 3 times after stirring 10 times).
3. The washed rice was put into the pot.
4. 560 g of water was added.
5. The rice was leveled so that the surface of the rice was flat.
6. 4 g of the oil or fat in 1. was put into the center portion of the surface of the rice, and the mixture was stirred.
7. The rice cooking was started.
8. After the rice cooking was completed, the degree of dispersion of the colored portion inside the surface of the cooked rice, the bottom surface, the side surface, and the rice after being taken out from the pot upside down, and the rice after being loosened with a rice scoop were imaged.

Regarding the dispersibility of the oil or fat in each example of the rice obtained above, the results of the observation by two expert panelists on the degree of dispersion of the colored portions on the surface, the bottom surface, the side surface, and the inside of the rice were combined and evaluated according to the following standard. The control example was scored as 1 point, with a maximum of 5 points. 3 points or more was considered acceptable.

### (Evaluation Criteria)

### (Dispersibility)

1: oil or fat were not dispersed at all and were biased
2: oil or fat were almost not dispersed and were biased
3: oil or fat were partially biased, but were uniformly dispersed to some extent
4: oil or fat were almost not biased, and were substantially uniformly dispersed
5: oil or fat were uniformly dispersed

### <Solid Fat Content (SFC)>

For the oil or fat composition for food preparation of Control Examples 1 to 3 and Examples 10 to 25, the solid fat content (SFC) at 10° C., 20° C., 30° C., and 35° C. was measured according to Method I described in AOCS Official Method Cd 16-93. The results are shown in Table 2.

TABLE 2

| | | Control | Example | Example | Example | Example |
|---|---|---|---|---|---|---|
| | | Example 2 | 10 | 11 | 12 | 13 |
| Formulation | Rapeseed oil | 100 | | | | |
| (parts by mass) | Soybean oil | | | | | |
| | High oleic sunflower oil | | | | | |
| | Transesterified oil | | 100 | 100 | 100 | 100 |
| | Glyceryl tritetradecanoate | | | | | |
| Transesterified | Rapeseed oil | | 98 | 96.5 | 95 | 92 |
| oil formulation | Soybean oil | | | | | |
| (parts by mass) | High oleic sunflower oil | | | | | |
| | Glyceryl tritridecanoate | | | | | |
| | Glyceryl tritetradecanoate | | 2 | 3.5 | 5 | 8 |
| | Glyceryl tripentadecanoate | | | | | |
| Fatty acid content | C12:0 | | | | | |
| (% by mass) | C13:0 | | | | | |
| | C14:0 | | 2.1 | 3.6 | 5.1 | 8.1 |
| | C15:0 | | | | | |
| | C16:0 | 3.9 | 10.0 | 9.9 | 9.7 | 9.4 |
| | C16:1 | 0.2 | 0.1 | 0.1 | 0.1 | 0.1 |
| | C18:0 | 1.7 | 3.7 | 3.6 | 3.6 | 3.5 |
| | C18:1 | 65.3 | 24.3 | 23.9 | 23.6 | 22.8 |
| | C18:2 | 18.5 | 51.7 | 51.0 | 50.2 | 48.6 |
| | C18:3 | 7.0 | 6.1 | 6.0 | 5.9 | 5.7 |
| | C20:0 | 0.6 | 0.3 | 0.3 | 0.3 | 0.3 |
| | C20:1 | 1.2 | 0.2 | 0.2 | 0.2 | 0.2 |
| | C22:0 | 0.3 | 0.4 | 0.4 | 0.4 | 0.4 |
| C13:0 to C15:0 | | 0.0 | 2.1 | 3.6 | 5.1 | 8.1 |
| C12:0/C13:0 to C15:0 | | 0.0 | 0.0 | 0.0 | 0.0 | 0.0 |
| C18 unsaturated fatty acid | | 90.8 | 82.1 | 80.9 | 79.6 | 77.1 |
| Saturated fatty acid (SFA) | | 6.4 | 16.5 | 17.8 | 19.1 | 21.6 |
| Polyunsaturated fatty acid (PUFA) | | 25.5 | 57.8 | 56.9 | 56.1 | 54.3 |
| Iodine value | | 107.7 | 126.7 | 124.7 | 122.8 | 118.9 |
| SFC (%) | 10° C. | 0.0 | 0.0 | 0.0 | 0.0 | 0.2 |
| | 20° C. | 0.0 | 0.0 | 0.0 | 0.0 | 0.0 |
| | 30° C. | 0.0 | 0.0 | 0.1 | 0.0 | 0.0 |
| | 35° C. | 0.0 | 0.0 | 0.0 | 0.1 | 0.0 |
| Frying oil | Oiliness | 3.0 | 3.3 | 3.8 | 4.2 | 4.5 |
| | Oily odor | 3.0 | 3.2 | 3.3 | 3.8 | 3.8 |
| | Texture (crispiness) | 3.0 | 3.2 | 3.7 | 4.2 | 4.5 |
| Coating oil | Hardness | 0.0 | 1.0 | 1.0 | 1.0 | 1.5 |
| | Stickiness | 0.0 | 0.0 | 0.0 | 1.0 | 1.5 |
| anti-sticking oil | time until noodle is loosened (with | 1.00 | 0.41 | 0.27 | 0.29 | 0.32 |
| for noodles | respect to control example) | | | | | |
| Stir-frying oil | residual rate of rice in frying pan | 1.00 | 0.86 | 0.02 | 0.56 | 0.47 |
| | (with respect to control example) | | | | | |
| Mayonnaise | Emulsifying properties | 5 | 5 | 5 | — | 5 |
| | Emulsification stability | 5 | 5 | 5 | — | 5 |
| Anti-sticking oil | Dispersibility | 1 | — | — | — | — |
| for rice cooking | | | | | | |
| | | Example | Example | Example | Example | Example |
| | | 14 | 15 | 16 | 17 | 18 |
| Formulation | Rapeseed oil | | | | | |
| (parts by mass) | Soybean oil | | | | | |
| | High oleic sunflower oil | | | | | |
| | Transesterified oil | 100 | 100 | 100 | 100 | 100 |
| | Glyceryl tritetradecanoate | | | | | |
| Transesterified | Rapeseed oil | 75 | 55 | 30 | 95.0 | 75.0 |
| oil formulation | Soybean oil | | | | | |
| (parts by mass) | High oleic sunflower oil | | | | | |
| | Glyceryl tritridecanoate | | | | 1.6 | 7.8 |
| | Glyceryl tritetradecanoate | 25 | 45 | 70 | 1.7 | 8.3 |
| | Glyceryl tripentadecanoate | | | | 1.8 | 8.8 |
| Fatty acid content | C12:0 | | | | | |
| (% by mass) | C13:0 | | | | 1.6 | 7.8 |
| | C14:0 | 25.0 | 45.0 | 70.0 | 1.7 | 8.4 |
| | C15:0 | | | | 1.8 | 8.8 |
| | C16:0 | 7.7 | 5.6 | 3.1 | 9.7 | 7.7 |
| | C16:1 | 0.1 | 0.0 | 0.0 | 0.1 | 0.1 |
| | C18:0 | 2.8 | 2.1 | 1.1 | 3.6 | 2.8 |
| | C18:1 | 18.6 | 13.6 | 7.4 | 23.6 | 18.6 |
| | C18:2 | 39.6 | 29.0 | 15.8 | 50.2 | 39.6 |
| | C18:3 | 4.6 | 3.4 | 1.9 | 5.9 | 4.6 |
| | C20:0 | 0.3 | 0.2 | 0.1 | 0.3 | 0.3 |
| | C20:1 | 0.2 | 0.1 | 0.1 | 0.2 | 0.2 |
| | C22:0 | 0.3 | 0.2 | 0.1 | 0.4 | 0.3 |
| C13:0 to C15:0 | | 25.0 | 45.0 | 70.0 | 5.1 | 25.0 |
| C12:0/C13:0 to C15:0 | | 0.0 | 0.0 | 0.0 | 0.0 | 0.0 |
| C18 unsaturated fatty acid | | 62.8 | 46.1 | 25.1 | 79.6 | 62.8 |
| Saturated fatty acid (SFA) | | 36.1 | 53.1 | 74.4 | 19.1 | 36.1 |
| Polyunsaturated fatty acid (PUFA) | | 44.3 | 32.5 | 17.7 | 56.0 | 44.3 |
| Iodine value | | 96.9 | 71.1 | 38.8 | 122.8 | 96.9 |
| SFC (%) | 10° C. | 9.8 | 42.0 | 84.5 | 0.1 | 8.8 |
| | 20° C. | 1.4 | 18.2 | 64.8 | 0.1 | 1.4 |
| | 30° C. | 0.2 | 5.1 | 40.8 | 0.0 | 0.1 |
| | 35° C. | 0.0 | 0.4 | 32.2 | 0.0 | 0.0 |
| Frying oil | Oiliness | 4.8 | 4.8 | 5.0 | 4.1 | 4.3 |
| | Oily odor | 4.0 | 4.2 | 5.0 | 4.0 | 4.0 |
| | Texture (crispiness) | 4.8 | 4.8 | 5.0 | 4.5 | 4.6 |
| Coating oil | Hardness | 1.0 | — | — | 1.0 | 0.9 |
| | Stickiness | 1.0 | — | — | 0.9 | 0.8 |
| anti-sticking oil | time until noodle is loosened (with | 0.45 | — | — | 0.36 | 0.41 |
| for noodles | respect to control example) | | | | | |
| Stir-frying oil | residual rate of rice in frying pan | 0.41 | — | — | 0.45 | 0.28 |
| | (with respect to control example) | | | | | |
| Mayonnaise | Emulsifying properties | — | — | — | 5 | 5 |
| | Emulsification stability | — | — | — | 5 | 3 |
| Anti-sticking oil | Dispersibility | — | — | 4 | — | — |
| for rice cooking | | | | | | |
| | | Example | Example | Example | Example | Control |
| | | 19 | 20 | 21 | 22 | Example 1 |
| Formulation | Rapeseed oil | | | 80 | 92 | |
| (parts by mass) | Soybean oil | | | | | 100 |
| | High oleic sunflower oil | | | | | |
| | Transesterified oil | 100 | 100 | 20 | | |
| | Glyceryl tritetradecanoate | | | | 8 | |
| Transesterified | Rapeseed oil | 95.0 | 75.0 | 55 | | |
| oil formulation | Soybean oil | | | | | |
| (parts by mass) | High oleic sunflower oil | | | | | |
| | Glyceryl tritridecanoate | 0.5 | 2.4 | | | |
| | Glyceryl tritetradecanoate | 4.5 | 21.3 | 45 | | |
| | Glyceryl tripentadecanoate | 0.3 | 1.3 | | | |
| Fatty acid content | C12:0 | | | | | |
| (% by mass) | C13:0 | 0.5 | 2.4 | | | |
| | C14:0 | 4.3 | 21.4 | 9.0 | 8.0 | 0.1 |
| | C15:0 | 0.3 | 1.3 | | | |
| | C16:0 | 9.7 | 7.7 | 1.2 | 3.6 | 10.2 |
| | C16:1 | 0.1 | 0.1 | 0.2 | 0.2 | 0.1 |
| | C18:0 | 3.6 | 2.8 | 1.8 | 1.5 | 3.8 |
| | C18:1 | 23.6 | 18.6 | 55.0 | 60.1 | 24.8 |
| | C18:2 | 50.2 | 39.6 | 20.6 | 17.0 | 52.8 |
| | C18:3 | 5.9 | 4.6 | 6.3 | 6.4 | 6.2 |
| | C20:0 | 0.3 | 0.3 | 0.5 | 0.5 | 0.3 |
| | C20:1 | 0.2 | 0.2 | 1.0 | 1.1 | 0.2 |
| | C22:0 | 0.4 | 0.3 | 0.3 | 0.3 | 0.4 |
| C13:0 to C15:0 | | 5.1 | 25.0 | 9.0 | 8.0 | 0.1 |
| C12:0/C13:0 to C15:0 | | 0.0 | 0.0 | 0.0 | 0.0 | 0.0 |
| C18 unsaturated fatty acid | | 79.6 | 62.8 | 81.9 | 83.6 | 83.8 |
| Saturated fatty acid (SFA) | | 19.1 | 36.1 | 15.8 | 13.9 | 14.8 |
| Polyunsaturated fatty acid (PUFA) | | 56.0 | 44.3 | 26.9 | 23.5 | 59.0 |
| Iodine value | | 122.8 | 96.9 | 100.3 | 99.0 | 129.3 |
| SFC (%) | 10° C. | 0.0 | 9.3 | 2.8 | 7.7 | 0.0 |
| | 20° C. | 0.0 | 1.2 | 1.2 | 6.0 | 0.0 |
| | 30° C. | 0.1 | 0.0 | 0.0 | 4.1 | 0.0 |
| | 35° C. | 0.0 | 0.1 | 0.0 | 2.5 | 0.0 |
| Frying oil | Oiliness | 4.0 | 4.0 | 4.1 | 4.5 | 3.0 |
| | Oily odor | 3.8 | 3.8 | 3.9 | 3.8 | 3.0 |
| | Texture (crispiness) | 4.5 | 4.5 | 4.1 | 4.4 | 3.0 |
| Coating oil | Hardness | 1.0 | 1.3 | 1.3 | 1.6 | 0.0 |
| | Stickiness | 1.1 | 0.9 | 1.0 | 1.1 | 0.0 |
| anti-sticking oil | time until noodle is loosened (with | 0.41 | 0.36 | 0.36 | 0.32 | 1.00 |
| for noodles | respect to control example) | | | | | |
| Stir-frying oil | residual rate of rice in frying pan | 0.27 | 0.52 | 0.59 | 0.48 | 1.00 |
| | (with respect to control example) | | | | | |
| Mayonnaise | Emulsifying properties | 5 | 5 | 3 | — | — |
| | Emulsification stability | 5 | 3 | 3 | — | — |
| Anti-sticking oil | Dispersibility | — | — | — | — | — |
| for rice cooking | | | | | | |

| | | Example | Example | Control | Example |
|---|---|---|---|---|---|
| | | 23 | 24 | Example 3 | 25 |
| Formulation | Rapeseed oil | | | | |
| (parts by mass) | Soybean oil | | | | |
| | High oleic sunflower oil | | | 100 | |
| | Transesterified oil | 100 | 100 | | 100 |
| | Glyceryl tritetradecanoate | | | | |
| Transesterified | Rapeseed oil | | | | |
| oil formulation | Soybean oil | 92 | 90 | | |
| (parts by mass) | High oleic sunflower oil | | | | 92 |
| | Glyceryl tritridecanoate | | | | |
| | Glyceryl tritetradecanoate | 8 | 10 | | 8 |
| | Glyceryl tripentadecanoate | | | | |
| Fatty acid content | C12:0 | | | | |
| (% by mass) | C13:0 | | | | |
| | C14:0 | 8.0 | 10.0 | | 8.0 |
| | C15:0 | | | | |
| | C16:0 | 3.6 | 3.5 | 4.1 | 3.8 |
| | C16:1 | 0.2 | 0.2 | 0.1 | 0.1 |
| | C18:0 | 1.5 | 1.5 | 2.7 | 2.5 |
| | C18:1 | 60.1 | 58.8 | 83.2 | 76.5 |
| | C18:2 | 17.0 | 16.7 | 7.8 | 7.2 |
| | C18:3 | 6.4 | 6.3 | 0.3 | 0.3 |
| | C20:0 | 0.5 | 0.5 | 0.2 | 0.2 |
| | C20:1 | 1.2 | 1.1 | 0.2 | 0.2 |
| | C22:0 | 0.3 | 0.3 | 0.9 | 0.8 |
| C13:0 to C15:0 | | 8.0 | 10.0 | 0.0 | 8.0 |
| C12:0/C13:0 to C15:0 | | 0.0 | 0.0 | 0.0 | 0.0 |
| C18 unsaturated fatty acid | | 83.6 | 81.7 | 91.3 | 84.0 |
| Saturated fatty acid (SFA) | | 13.9 | 15.8 | 8.0 | 15.3 |
| Polyunsaturated fatty acid (PUFA) | | 23.5 | 23.0 | 8.1 | 7.4 |
| Iodine value | | 99.0 | 96.9 | 86.1 | 79.2 |
| SFC (%) | 10° C. | 3.8 | 4.4 | 0.0 | 0.3 |
| | 20° C. | 1.0 | 0.6 | 0.0 | 0.1 |
| | 30° C. | 0.0 | 0.0 | 0.0 | 0.0 |
| | 35° C. | 0.0 | 0.0 | 0.0 | 0.0 |
| Frying oil | Oiliness | 4.1 | 4.5 | 3.0 | 4.5 |
| | Oily odor | 3.4 | 3.5 | 3.0 | 3.5 |
| | Texture (crispiness) | 3.8 | 4.0 | 3.0 | 3.6 |
| Coating oil | Hardness | 1.3 | 0.9 | 0.0 | 1.3 |
| | Stickiness | 1.0 | 0.5 | 0.0 | 1.0 |
| anti-sticking oil | time until noodle is loosened (with | 0.77 | 0.79 | 1.00 | 0.48 |
| for noodles | respect to control example) | | | | |
| Stir-frying oil | residual rate of rice in frying pan | 0.60 | 0.96 | — | — |
| | (with respect to control example) | | | | |
| Mayonnaise | Emulsifying properties | — | — | — | — |
| | Emulsification stability | — | — | — | — |
| Anti-sticking oil | Dispersibility | — | — | — | — |
| for rice cooking | | | | | |

As shown in Table 2, in the examples, in a case of being used as frying oil, oiliness and oily odor were suppressed and the texture was improved as compared with the control example, and in a case of being used as stir-frying oil, the adhesion of rice to the frying pan was suppressed as compared with the control example.

In addition, in a case of being used as anti-sticking oil for noodles, the time until the noodle is loosened is shorter than that of the control example, and in a case of being used as a coating oil, the balance between hardness and softness of the noodle is improved as compared with the control example.

In addition, it was confirmed that the emulsifier has sufficient emulsifying properties and emulsification stability in a case of being used for preparing mayonnaise.

In addition, in a case of being used in the anti-sticking oil for rice cooking, the dispersibility of the oil or fat was improved as compared with the control example.

### Evaluation of Powdered Oil or Fat (Examples 26 to 32 and Comparative Examples 5 to 7)

Powdered oils or fats were produced and evaluated as follows for the oil or fat of each example. In addition, the production of the transesterified oil was performed in the same manner as in <Method for producing transesterified oil> described above according to the formulation of the transesterified oil in Table 3.

TABLE 3

| | | Transes- | Transes- | Transes- |
|---|---|---|---|---|
| | | terified | terified | terified |
| | | oil 1 | oil 2 | oil 3 |
| Transesterified | Rapeseed oil | | | 30 |
| oil formulation | Glyceryl | 31.4 | 9.4 | |
| (parts by mass) | tritridecanoate | | | |
| | Glyceryl | 33.3 | 85.2 | 70 |
| | tritetradecanoate | | | |
| | Glyceryl | 35.3 | 5.3 | |
| | tripentadecanoate | | | |

The following raw materials were used for the raw material of the powdered oil or fat.

### (Formulation 1)

Acid casein: Lactic Casein, manufactured by Westland Co-operative Dairy Company Ltd.
Sodium hydroxide: manufactured by Tosoh Corporation
Corn syrup: FUJISYRUP C-75S (average molecular weight: 700, DE28, moisture content: 25%), manufactured by KATO CHEMICAL CO., LTD.

### (Formulation 2)

Gum arabic: Arabic call SS, manufactured by SANEI CHEMICAL INDUSTRY CO., LTD.
Dextrin: TK-16 (DE18), manufactured by Matsutani Co., Ltd.

### <Method for Producing Powdered Oils or Fats of Formulation 1 and Formulation 2>

### 1-1. Preparation of Water Phase Raw Material (Formulation 1)

6.844 parts by mass of acid casein and 0.156 parts by mass of sodium hydroxide were mixed with 100 parts by mass of water and subjected to a neutralization reaction to obtain an aqueous solution containing sodium caseinate. 23 parts by mass (in terms of solid content) of corn syrup was mixed with the obtained aqueous solution to obtain a water phase raw material.

### 1-2. Preparation of Water Phase Raw Material (Formulation 2)

150 parts by mass of water, 35 parts by mass of dextrin, and 25 parts by mass of gum arabic were mixed with each other to obtain a water phase raw material.

### 2. High-Pressure Emulsification and Drying

The water phase raw material obtained in 1-1. (Formulation 1) above and 70 parts by mass of the oil or fat of each example heated and dissolved at 80° C. were mixed and stirred to obtain a mixed solution 1. In addition, the water phase raw material prepared in 1-2. (Formulation 2) described above was mixed with 40 parts by mass of the oil or fat of each example heated and dissolved at 80° C., and the mixture was stirred to obtain a mixed solution 2.

The obtained mixed solution 1 or mixed solution 2 was treated at 500 bar using a high-pressure emulsifier (LAB-2000, manufactured by SPX FLOW Technology Japan, Inc.) to obtain an oil-in-water droplet type emulsion. The obtained emulsion was dried and powdered using a spray dryer (B-290, manufactured by BUCHI K.K., INLET: 175° C., pump output: 50%, spray air flow rate: 600 L/hour) to obtain a powdered oil or fat of each example.

### <Method for Producing Powdered Oil or Fat of Formulation 3>

The oil or fat of each example heated and dissolved at 80° C. was subjected to spray cooling and solidification at room temperature using a spray dryer equipped with a spray cooling accessory to obtain a powdered oil or fat of each example.

### (Powder Fluidity)

For the powdered oil or fat of each example, a loose bulk density (g/100 mL) and a tight bulk density (g/100 mL) were each measured twice with a powder property evaluation device (Powder Tester PT-X, manufactured by Hosokawa Micron Corporation), and the degree of compression (%) was calculated according to the following expression using the average value. It is noted that the smaller the numerical value of the degree of compression, the better the powder fluidity.

$$Degree of compression ( \% ) = ( ( Tight bulk density ( g / 100 mL ) - Loose bulk density ( g / 100 mL ) ) / Tight bulk density ( g / 10 \; 0 mL ) ) \times 100 \qquad Expression$$

### (Emulsification Stability)

10 g of the powdered oil or fat of each example was put into a polybag (craft inner bag), and stored in a constant-temperature tank at 60° C. for 10 days.

Using a laser diffraction type particle size distribution measuring device (LA-960, manufactured by Horiba, Ltd.), the fat globule diameters (median diameters) (μm) of the powdered oil or fat before and after storage at 60° C. in each example were measured under the following conditions. The median diameter means a particle diameter at which a distribution curve with the particle diameter on the horizontal axis and the cumulative percentage on the vertical axis intersects the horizontal axis at 50%.

### (Measurement Condition)

Refractive index: 1.60-0.5i
Dispersion medium: water

Further, the change magnification was calculated by the following expression. The smaller the change magnification, the higher the emulsification stability.

$$change magnification = fat globule diameter ( μm ) after storage / fat globule diameter ( μm ) before storage \qquad Expression$$

### (Evaluation of Flavor)

A coffee liquid was prepared by the following procedure.

2 g of instant coffee (Blendy, manufactured by Ajinomoto AGF, Inc.), 1.5 g of the powdered oil or fat of each example, 3 g of granulated sugar (manufactured by DM Mitsui Sugar Co., Ltd.), and 0.2 g of disodium hydrogen phosphate (manufactured by Taihei Chemical Industrial Co., Ltd.) were added to 160 g of hot water and mixed well until dissolved.

The pH of the obtained coffee liquid was 6.6 to 6.7.

The obtained coffee liquid was tasted by four expert panelists and evaluated based on the following evaluation criteria. The score was determined by the consensus of the expert panelists. 3 points or more was considered acceptable. The results are shown in Table 4.

### (Evaluation Criteria)

5: there was no off-flavor, and the richness of the oil or fat was extremely strong
4: there was no off-flavor, and the richness of the oil or fat was strong
3: there was little off-flavor, and the richness of the oil or fat was felt
2: there was off-flavor, and the richness of the oil or fat was not felt very much
1: there was extremely strong off-flavor, and a negative flavor of the oil or fat was felt

TABLE 4

| | | Comparative | | | | |
|---|---|---|---|---|---|---|
| | | Example 6 | Example 26 | Example 27 | Example 28 | Example 29 |
| Powdered oil or fat formulation | | Formulation 1 | Formulation 1 | Formulation 1 | Formulation 1 | Formulation 1 |
| Formulation | Rapeseed oil | 100 | | 45 | 77.5 | 45 |
| (parts by mass) | Glyceryl tritetradecanoate | | 100 | 55 | 22.5 | |
| | Transesterified oil 1 | | | | | 55 |
| | Transesterified oil 2 | | | | | |
| | Transesterified oil 3 | | | | | |
| | Palm olein | | | | | |
| | Palm kernel extreme hard oil | | | | | |
| Fatty acid | C8:0 | | | | | |
| content | C10:0 | | | | | |
| (% by mass) | C12:0 | | | | | |
| | C13:0 | | | | | 17.3 |
| | C14:0 | | 100.0 | 55.0 | 22.5 | 18.3 |
| | C15:0 | | | | | 19.4 |
| | C16:0 | 3.9 | | 1.7 | 3.0 | 1.7 |
| | C16:1 | 0.2 | | 0.1 | 0.1 | 0.1 |
| | C18:0 | 1.7 | | 0.8 | 1.3 | 0.8 |
| | C18:1 | 65.3 | | 29.4 | 50.6 | 29.4 |
| | C18:2 | 18.5 | | 8.3 | 14.4 | 8.3 |
| | C18:3 | 7.0 | | 3.1 | 5.4 | 3.1 |
| | C20:0 | 0.6 | | 0.2 | 0.4 | 0.2 |
| | C20:1 | 1.2 | | 0.5 | 0.9 | 0.5 |
| | C22:0 | 0.3 | | 0.1 | 0.2 | 0.1 |
| C13:0 to C15:0 | | 0.0 | 100.0 | 55.0 | 22.5 | 55.0 |
| C12:0/C13:0 to C15:0 | | 0.0 | 0.0 | 0.0 | 0.0 | 0.0 |
| C18 unsaturated fatty acid | | 90.8 | 0.0 | 40.9 | 70.4 | 40.9 |
| Saturated fatty acid (SFA) | | 6.4 | 100.0 | 57.9 | 27.5 | 57.9 |
| Polyunsaturated fatty acid (PUFA) | | 25.5 | 0.0 | 11.5 | 19.8 | 11.5 |
| Iodine value | | 107.7 | 0.0 | 48.4 | 83.4 | 48.4 |
| Powder fluidity | Loose bulk density (g/100 mL) | 18.4 | 29.9 | 23.9 | 19.0 | 22.5 |
| | Tight bulk density (g/100 mL) | 47.2 | 48.6 | 51.7 | 44.9 | 48.2 |
| | Degree of compression (%) | 60.9 | 38.6 | 53.8 | 57.6 | 53.3 |
| Emulsification | Before storage | 0.3 | 0.2 | 0.2 | 0.2 | 0.2 |
| stability | After storage | 1.2 | 0.2 | 0.2 | 0.8 | 0.3 |
| | Change magnification | 3.9 | 1.2 | 1.2 | 3.5 | 1.6 |
| Evaluation of flavor | | 1 | 5 | 4 | 3 | 4 |
| | | | Comparative | | Comparative | |
| | | Example 30 | Example 7 | Example 31 | Example 5 | Example 32 |
| Powdered oil or fat formulation | | Formulation 1 | Formulation 2 | Formulation 2 | Formulation 3 | Formulation 3 |
| Formulation | Rapeseed oil | 45 | | | | |
| (parts by mass) | Glyceryl tritetradecanoate | | | | | 100 |
| | Transesterified oil 1 | | | | | |
| | Transesterified oil 2 | 55 | | | | |
| | Transesterified oil 3 | | | 90 | | |
| | Palm olein | | 100 | 10 | | |
| | Palm kernel extreme hard oil | | | | 100 | |
| Fatty acid | C8:0 | | | | 3.4 | |
| content | C10:0 | | | | 3.1 | |
| (% by mass) | C12:0 | | 0.3 | | 47.9 | |
| | C13:0 | 5.2 | | | | |
| | C14:0 | 46.9 | 1.0 | 63.1 | 16.1 | 100.0 |
| | C15:0 | 2.9 | | | | |
| | C16:0 | 1.7 | 31.4 | 4.2 | 8.4 | |
| | C16:1 | 0.1 | 0.2 | 0.1 | | |
| | C18:0 | 0.8 | 3.6 | 0.8 | 20.7 | |
| | C18:1 | 29.4 | 48.3 | 22.5 | | |
| | C18:2 | 8.3 | 14.8 | 6.5 | | |
| | C18:3 | 3.1 | 0.3 | 1.9 | | |
| | C20:0 | 0.2 | 0.2 | 0.2 | | |
| | C20:1 | 0.5 | | 0.3 | | |
| | C22:0 | 0.1 | | 0.1 | | |
| C13:0 to C15:0 | | 55.0 | 1.0 | 63.1 | 16.1 | 100.0 |
| C12:0/C13:0 to C15:0 | | 0.0 | 0.3 | 0.0 | 3.0 | 0.0 |
| C18 unsaturated fatty acid | | 40.9 | 63.4 | 30.9 | 0.0 | 0.0 |
| Saturated fatty acid (SFA) | | 57.9 | 36.5 | 68.3 | 99.6 | 100.0 |
| Polyunsaturated fatty acid (PUFA) | | 11.5 | 15.1 | 8.4 | 0.0 | 0.0 |
| Iodine value | | 48.4 | 68.1 | 35.9 | 0.0 | 0.0 |
| Powder fluidity | Loose bulk density (g/100 mL) | 26.6 | 29.3 | 32.4 | 26.7 | 24.6 |
| | Tight bulk density (g/100 mL) | 51.9 | 69.9 | 67.2 | 47.5 | 36.9 |
| | Degree of compression (%) | 48.8 | 58.1 | 51.7 | 43.8 | 33.3 |
| Emulsification | Before storage | 0.2 | 1.4 | 1.6 | — | — |
| stability | After storage | 0.3 | 2.5 | 2.1 | — | — |
| | Change magnification | 1.8 | 1.7 | 1.3 | — | — |

| | | | | | |
|---|---|---|---|---|---|
| Evaluation of flavor | 4 | 1 | 4 | — | — |

As shown in Table 4, in Examples, powder fluidity and emulsification stability of the powdered oil or fat were improved, and the flavor was also good, as compared with Comparative Examples.

### Cooking Evaluation (Control Example 1′ and Examples 33 to 41)

The evaluation of the frying oil was performed for the oils or fats of each example in the same manner as in Control Examples 1 to 3 and Examples 10 to 25. For each evaluation, Control Example 1′ was used as a standard. In addition, Control Example 1′ was evaluated at the same time as Examples 33 to 41 using the same formulation of the oil or fat as that of Control Example 1 described above. The results are shown in Table 5.

TABLE 5

| | | Control | Example | Example | Example | Example |
|---|---|---|---|---|---|---|
| | | Example 1′ | 33 | 34 | 35 | 36 |
| Formulation | Soybean oil | 100 | 85 | | | |
| (parts by mass) | Transesterified oil | | | 100 | 100 | 100 |
| | Glyceryl tritetradecanoate | | 10 | | | |
| | MCT | | 5 | | | |
| | Linseed oil | | | | | |
| Transesterified | Soybean oil | | | 91 | 81 | 73 |
| oil formulation | Glyceryl tritetradecanoate | | | 4 | 3 | 2 |
| (parts by mass) | Palm kernel oil | | | 5 | 16 | 25 |
| | MCT | | | | | |
| Fatty acid | C8:0 | | 4.3 | 0.2 | 0.5 | 0.8 |
| content | C10:0 | | 0.7 | 0.2 | 0.5 | 0.8 |
| (% by mass) | C12:0 | | | 2.4 | 7.7 | 12.0 |
| | C13:0 | | | | | |
| | C14:0 | 0.1 | 10.1 | 4.9 | 5.6 | 6.1 |
| | C15:0 | | | | | |
| | C16:0 | 10.2 | 8.7 | 9.7 | 9.6 | 9.6 |
| | C16:1 | 0.1 | 0.1 | 0.1 | 0.1 | 0.1 |
| | C18:0 | 3.8 | 3.2 | 3.5 | 3.4 | 3.3 |
| | C18:1 | 24.8 | 21.1 | 23.4 | 22.7 | 22.1 |
| | C18:2 | 52.8 | 44.9 | 48.2 | 43.2 | 39.2 |
| | C18:3 | 6.2 | 5.3 | 5.6 | 5.0 | 4.5 |
| | C20:0 | 0.3 | 0.3 | 0.3 | 0.3 | 0.3 |
| | C20:1 | 0.2 | 0.2 | 0.2 | 0.2 | 0.2 |
| | C22:0 | 0.4 | 0.3 | 0.4 | 0.3 | 0.3 |
| C13:0 to C15:0 | | 0.1 | 10.1 | 4.9 | 5.6 | 6.1 |
| C12:0/C13:0 to C15:0 | | 0.0 | 0.0 | 0.5 | 1.4 | 2.0 |
| C18 unsaturated fatty acid | | 83.8 | 71.2 | 77.2 | 70.8 | 65.8 |
| Saturated fatty acid (SFA) | | 14.8 | 27.6 | 21.5 | 28.0 | 33.1 |
| Polyunsaturated fatty acid (PUFA) | | 59.0 | 50.2 | 53.8 | 48.2 | 43.7 |
| Iodine value | | 129.3 | 109.9 | 118.5 | 107.6 | 98.9 |
| Frying oil | Oiliness | 3.0 | 3.4 | 3.8 | 3.4 | 3.6 |
| | Oily odor | 3.0 | 3.3 | 3.9 | 3.6 | 4.0 |
| | Texture (crispiness) | 3.0 | 3.9 | 3.5 | 3.9 | 4.0 |

| | | Example | Example | Example | Example | Example |
|---|---|---|---|---|---|---|
| | | 37 | 38 | 39 | 40 | 41 |
| Formulation | Soybean oil | | | | | |
| (parts by mass) | Transesterified oil | 100 | 100 | 100 | 100 | 70 |
| | Glyceryl tritetradecanoate | | | | | |
| | MCT | | | | | |
| | Linseed oil | | | | | 30 |
| Transesterified | Soybean oil | 82 | 80 | 75 | 70 | 85 |
| oil formulation | Glyceryl tritetradecanoate | 8 | 10 | 10 | 10 | 15 |
| (parts by mass) | Palm kernel oil | 10 | | | | |
| | MCT | | 10 | 15 | 20 | |
| Fatty acid | C8:0 | 0.3 | 8.6 | 12.9 | 17.1 | |
| content | C10:0 | 0.3 | 1.4 | 2.1 | 2.9 | |
| (% by mass) | C12:0 | 4.8 | | | | |
| | C13:0 | | | | | |
| | C14:0 | 9.7 | 10.0 | 10.0 | 10.0 | 10.5 |
| | C15:0 | | | | | |
| | C16:0 | 9.2 | 8.2 | 7.7 | 7.2 | 7.7 |
| | C16:1 | 0.1 | 0.1 | 0.1 | 0.1 | 0.1 |
| | C18:0 | 3.3 | 3.0 | 2.8 | 2.6 | 3.4 |
| | C18:1 | 21.9 | 19.8 | 18.6 | 17.4 | 21.1 |
| | C18:2 | 43.5 | 42.2 | 39.6 | 37.0 | 36.5 |
| | C18:3 | 5.1 | 5.0 | 4.6 | 4.3 | 19.3 |
| | C20:0 | 0.3 | 0.3 | 0.3 | 0.2 | 0.2 |
| | C20:1 | 0.2 | 0.2 | 0.2 | 0.2 | 0.2 |
| | C22:0 | 0.3 | 0.3 | 0.3 | 0.3 | 0.3 |
| C13:0 to C15:0 | | 9.7 | 10.0 | 10.0 | 10.0 | 10.5 |
| C12:0/C13:0 to C15:0 | | 0.5 | 0.0 | 0.0 | 0.0 | 0.0 |
| C18 unsaturated fatty acid | | 70.6 | 67.0 | 62.8 | 58.7 | 76.9 |
| Saturated fatty acid (SFA) | | 28.2 | 31.8 | 36.1 | 40.4 | 22.1 |
| Polyunsaturated fatty acid (PUFA) | | 48.6 | 47.2 | 44.3 | 41.3 | 55.8 |
| Iodine value | | 107.8 | 103.4 | 96.9 | 90.5 | 132.0 |
| Frying oil | Oiliness | 3.4 | 3.9 | 3.8 | 4.0 | 3.6 |
| | Oily odor | 3.8 | 3.5 | 3.5 | 3.6 | — |
| | Texture (crispiness) | 4.3 | 4.4 | 4.8 | 4.3 | 4.0 |

### Evaluation of Powdered Oil or Fat (Examples 42 and 43)

Powdered oils or fats were produced in the same manner as in Examples 26 to 32 and Comparative Examples 5 to 7 for the oil 5 or fat of each example, and the evaluation was performed. The results are shown in Table 6.

TABLE 6

| | | Exam- | Exam- |
|---|---|---|---|
| | | ple 42 | ple 43 |
| Powdered oil or fat formulation | | Formu- | Formu- |
| | | lation 1 | lation 1 |
| Formulation | Rapeseed oil | 60 | |
| (parts by | Glyceryl tritetradecanoate | 10 | 55 |
| mass) | Palm kernel extreme hard oil | 30 | |
| | MCT | | 45 |
| Fatty acid | C8:0 | 1.0 | 38.6 |
| content | C10:0 | 0.9 | 6.4 |
| (% by mass) | C12:0 | 14.4 | |
| | C13:0 | | |
| | C14:0 | 14.8 | 55.0 |
| | C15:0 | | |
| | C16:0 | 4.8 | |
| | C16:1 | 0.1 | |
| | C18:0 | 7.2 | |
| | C18:1 | 39.2 | |
| | C18:2 | 11.1 | |
| | C18:3 | 1.2 | |
| | C20:0 | 0.3 | |
| | C20:1 | 0.7 | |
| | C22:0 | 0.2 | |
| C13:0 to C15:0 | | 14.8 | 55.0 |
| C12:0/C13:0 to C15:0 | | 1.0 | 0.0 |
| C18 unsaturated fatty acid | | 54.5 | 0.0 |
| Saturated fatty acid (SFA) | | 43.8 | 100.0 |
| Polyunsaturated fatty acid (PUFA) | | 15.3 | 0.0 |
| Powder | Tight bulk density (g/100 mL) | 21.1 | 24.8 |
| fluidity | Loose bulk density (g/100 mL) | 47.9 | 53.0 |
| | Degree of compression (%) | 56.0 | 53.3 |
| Emulsification | Before storage | 0.2 | 0.2 |
| stability | After storage | 0.3 | 0.2 |
| | Change magnification | 1.3 | 1.1 |

| | | |
|---|---|---|
| Evaluation of flavor | 4 | 5 |

This application claims priority based on Japanese Patent Application No. 2023-055842 filed Mar. 30, 2023, the entire disclosure of which is incorporated herein by reference.

1. An oil or fat composition for food preparation comprising:
a glycerin fatty acid ester containing a fatty acid residue having 13 or more and 15 or less carbon atoms,
wherein in total fatty acids of the glycerin fatty acid ester, a content of a fatty acid having 13 or more and 15 or less carbon atoms is 1.8% by mass or more and 100% by mass or less and
in the total fatty acids of the glycerin fatty acid ester, a content of a fatty acid having 12 carbon atoms is 0 or more and 2.5 or less in terms of a mass ratio with respect to a content of the fatty acid having 13 or more and 15 or less carbon atoms (excluding an oil or fat composition for preparation of puff pastry margarine, and the oil or fat composition for food preparation that is milk fat, beef tallow, mutton tallow, ucuuba butter, murumuru butter, euglena oil, or margarine).

2. The oil or fat composition for food preparation according to claim 1,
wherein the fatty acid having 13 or more and 15 or less carbon atoms includes one kind or two or more kinds selected from the group consisting of tridecanoic acid, tetradecanoic acid, and pentadecanoic acid.

3. The oil or fat composition for food preparation according to claim 1,
wherein in the total fatty acids of the glycerin fatty acid ester, a content of a fatty acid having 12 carbon atoms is 0% by mass or more and 15% by mass or less.

4. The oil or fat composition for food preparation according to claim 1,
wherein in the total fatty acids of the glycerin fatty acid ester, a content of a fatty acid having 14 carbon atoms is 1.5% by mass or more and 100% by mass or less.

5. The oil or fat composition for food preparation according to claim 1,
wherein the glycerin fatty acid ester contains a transesterified oil.

6. The oil or fat composition for food preparation according to claim 1,
wherein the oil or fat composition for food preparation is used for cooking.

7. The oil or fat composition for food preparation according to claim 6,
wherein the oil or fat composition for food preparation is used for one kind selected from the group consisting of frying oil, coating oil, anti-sticking oil for noodles, stir-frying oil, and oil for raw use.

8. The oil or fat composition for food preparation according to claim 6,
wherein the oil or fat composition for food preparation is used for anti-sticking oil for rice cooking.

9. The oil or fat composition for food preparation according to claim 6,
wherein a solid fat content (SFC) of the oil or fat composition for food preparation at 10° C. is 0% or more and 90% or less.

10. The oil or fat composition for food preparation according to claim 6,
wherein a solid fat content (SFC) of the oil or fat composition for food preparation at 20° C. is 0% or more and 80% or less.

11. The oil or fat composition for food preparation according to claim 1,
wherein the oil or fat composition for food preparation is used for preparing a powdered oil or fat.

12. Food comprising:
the oil or fat composition for food preparation according to claim 1.

13. A powdered oil or fat comprising:
the oil or fat composition for food preparation according to claim 1.

14. A method for producing an oil or fat composition for food preparation according to claim 1, the method comprising:
a step of reacting a fatty acid having 13 or more and 15 or less carbon atoms with glycerin to produce a glycerin fatty acid ester.

15. The method for producing an oil or fat composition for food preparation according to claim 14, further comprising:
a step of subjecting the glycerin fatty acid ester obtained by reacting the fatty acid having 13 or more and 15 or less carbon atoms with the glycerin to a transesterification with an edible oil or fat containing a glycerin fatty acid ester other than the glycerin fatty acid ester.

16. A method for preparing food, comprising:
a step of preparing food using the oil or fat composition for food preparation according to claim 1.

17. A method for cooking food, comprising:
a step of cooking food using the oil or fat composition for food preparation according to claim 1.

18. A method for improving quality of food, comprising:
a step of preparing food using the oil or fat composition for food preparation according to claim 1.

19. A method for improving quality of cooked food, comprising:
a step of cooking food using the oil or fat composition for food preparation according to claim 1.
